(19) United States
(12) Patent Application Publication
(10) Pub. No.: US 2014/0056334 A1
(43) Pub. Date: Feb. 27, 2014

(54) ENHANCED COMMUNICATION OVER NETWORKS USING JOINT MATRIX DECOMPOSITIONS

(71) Applicants: Anatoly Khina, Kfar Vradim (IL); Ayal Hitron, Il (IL); Uri Erez, Tel Aviv (IL); Yuval Kochman, Boston, MA (US); Greogry W. Wornell, Wellesley, MA (US)

(72) Inventors: Anatoly Khina, Kfar Vradim (IL); Ayal Hitron, Il (IL); Uri Erez, Tel Aviv (IL); Yuval Kochman, Boston, MA (US); Greogry W. Wornell, Wellesley, MA (US)

(73) Assignees: MASSACHUSETTS INSTITUTE OF TECHNOLOGY, Cambridge, MA (US); RAMOT AT TEL-AVIV UNIVERSITY LTD., Tel Aviv (IL)

(21) Appl. No.: 13/876,310

(22) PCT Filed: Sep. 27, 2011
(86) PCT No.: PCT/IL11/00763

§ 371 Date: Nov. 4, 2013

Related U.S. Application Data
(60) Provisional application No. 61/386,656, filed on Sep. 27, 2010.

(51) Int. Cl. H04B 7/155; H04L 25/03; H04L 25/02

(52) U.S. Cl. CPC H04B 7/15564; H04L 25/0242; H04L 25/03898
USPC 375/211

(57) ABSTRACT

The disclosure describes examples of systems and methods for communication networks including multiple-input multiple output MIMO channels. In these examples, based on a novel decomposition of two or more channel matrices or functions thereof, a MIMO channel may be treated as a plurality of parallel scalar additive white Gaussian noise (AWGN) channels.

### CROSS REFERENCE TO RELATED APPLICATIONS

This application claims the benefit of U.S. Provisional Application 61/386,656, filed Sep. 27, 2010, which is hereby incorporated by reference herein.

### TECHNICAL FIELD

The disclosure relates to the field of communication over networks, and in particular to multiple-input multiple-output MIMO channels.

### BACKGROUND

High data rates and low implementation complexity are desirable in communication networks. However achieving optimal rates is a long-standing problem. The multiple-input multiple-output (MIMO) Gaussian channel has gained much attention over the past decade and MIMO Gaussian channels are a basic building block of many communication networks due to their potential to enhance the throughput of networks. Wireless communication widely uses MIMO techniques to obtain degrees of freedom. Unlike the single-input single output (SISO) channel, the MIMO channel is not degraded. Nevertheless capacity regions were established for some scenarios, such as the transfer of a private message, or the transfer of a common message with a single private message, and bounds were derived for other scenarios. A straightforward high performance transmission scheme for MIMO channels includes joint encoding and decoding of all antenna signals. However the high complexity of such a scheme impedes practical implementation.

Traditionally wireless networks were treated at two different levels: a physical layer local code which translates the wireless channels into “bit-pipes”, and a network code over the bit network. This separation is in general sub-optimal, as has been demonstrated in recent years by physical layer network coding (PNC) approaches. In the most basic variant of PNC (for single antenna nodes), relay nodes simply forward their inputs using power adjustment only (“amplify and forward”). This analog-PNC approach helps in opening network bottlenecks, by allowing a node to contribute even if the node cannot decode a message and indeed the approach is optimal in some cases. However analog-PNC suffers from noise accumulation. Without decoding, the relays also forward noise.

### SUMMARY

In one aspect, the disclosed subject matter provides a method of communicating at least one message, comprising: jointly decomposing at least two MIMO channel matrices or functions thereof, wherein a result of the decomposing includes triangular matrices and unitary matrices; determining how to split a rate of the at least one message into subrates corresponding to submessages of the at least one message based on diagonal values in the resulting triangular matrices; and transmitting or receiving elements relating to the at least one message.

In some examples, the method further comprises: determining codebooks corresponding to the determined subrates.

In some examples, the method further comprises: determining a function of a channel matrix, wherein the function of the channel matrix is decomposed rather than the channel matrix.

In some of these examples, the function includes an augmented matrix.

In some of these examples, the function takes into account a covariance matrix.

In some of these examples, the function takes into account a beamforming matrix.

In some examples of the method, two channel matrices or functions thereof are jointly decomposed.

In some examples of the method, three channel matrices or functions thereof are jointly decomposed.

In some examples of the method, the resulting triangular matrices have equal diagonals.

In some examples of the method, the elements may include codes designed for single input single output SISO additive white Gaussian noise AWGN channels corresponding to the determined subrates.

In some examples, the method further comprises, splitting a rate of the at least one message into the determined subrates corresponding to submessages; using codebooks to encode the submessages, wherein the codebooks correspond to the determined subrates; and multiplying a resulting unitary matrix or a function thereof by the encoded submessages to derive the elements for transmission.

In some of these examples, the function of the unitary matrix is a product of the resulting unitary matrix and a factor which was multiplied by a channel matrix in order to derive a function of the channel matrix.

In some of these examples, the function of the unitary matrix is a product of a submatrix of a Hermitian transpose of the resulting unitary matrix and a factor which was multiplied by a channel matrix in order to derive a function of the channel matrix.

In some of these examples, the at least one message includes a common message, the elements relating to the common message are transmitted via at least two MIMO channels whose channel matrices or functions thereof were jointly decomposed, and the resulting unitary matrix which is multiplied or whose function is multiplied is common to a decomposition of each the channel matrix or function thereof. In some cases of these examples, the at least one message also includes a private message.

In some of these examples, where the at least one message includes a private message, and the elements are to be transmitted to a relay node, the method further comprises: applying dirty paper coding; wherein the resulting unitary matrix or the function thereof is multiplied by the submessages which had been encoded using the codebooks and the dirty paper coding, and wherein the resulting unitary matrix which is multiplied or whose function is multiplied corresponds to a MIMO channel via which the elements are to be transmitted to the relay node. In some cases of these examples, the method further comprises receiving a function of the private message and of at least one other private message originating from at least one other node; and determining the at least one other private message.

In some of these examples, the elements are transmitted via a channel out of a plurality of possible channels which is not known beforehand or via a known channel with unknown noise.

In some of these examples, some of the elements are transmitted to one node and others of the elements are transmitted to a plurality of nodes.

In some examples, the method further comprises: multiplying elements which were received, by a unitary matrix resulting from the decomposing or by a function thereof; and decoding.

In some of these examples the function of the unitary matrix is a submatrix of a Hermitian transpose of the unitary matrix.

In some of these examples, where the at least one message includes a common message, elements relating to the common message had been transmitted via at least two MIMO channels, the unitary matrix is a unitary matrix corresponding to one of the channels via which the elements were received, and the decoding includes applying successive decoding based on a corresponding resulting triangular matrix and codebooks corresponding to the determined rate, the method further comprises combining results of the successive decoding to recover at least the common message.

In some of these examples, where the at least one message includes at least two private messages and the related elements were received from at least two nodes, the unitary matrix is a common unitary matrix resulting from a decomposition of each channel matrix or function thereof, and the decoding includes structured physical layer network coding PNC decoding, the method further comprises: encoding results of the structured PNC decoding to obtain a function of the private messages; and transmitting the function of the private messages to the at least two nodes.

In some of these examples, where the received elements include elements sent by a transmitting node and elements sent by a relay node, the unitary matrix resulted from a decomposition of an augmented matrix, and the decoding includes successive decoding based on a corresponding resulting triangular matrix and codebooks corresponding to the determined subrates, the method further comprises: combining results of the decoding to recover the at least one message. In some cases of these examples the method further comprises: reversing interleaving used for at least some of the elements.

In some of these examples, where the received elements include elements sent by a transmitting node to a relay node, the unitary matrix resulted from a decomposition of an augmented matrix, and the decoding includes applying successive decoding based on a corresponding resulting triangular matrix and codebooks corresponding to the determined subrates; the method further comprises: combining results of the decoding; multiplying results of the combining by a common unitary matrix resulting from the decomposing or by a function thereof to derive elements for transmitting to at least one other node; and transmitting the derived elements to the at least one other node.

In some of these examples, where the unitary matrix resulted from a decomposition of an augmented matrix which was formed in a block diagonal manner from channel matrices in a plurality of instances, and where the decoding includes applying successive decoding based on a corresponding resulting triangular matrix and codebooks corresponding to the determined subrates; the method further comprises: combining results of the decoding to recover the at least one message.

In another aspect, the disclosed subject matter provides a system for communicating at least one message, comprising: a decomposer operable to jointly decompose at least two MIMO channel matrices or functions thereof, wherein a result of the decomposing includes triangular matrices and unitary matrices; a rate determiner operable to determine how to split a rate of the at least one message into subrates corresponding to submessages of the at least one message based on diagonal values in the resulting triangular matrices; and antennas operable to transmit or receiving elements relating to the at least one message.

In some examples, the system further comprises: a codebook determiner operable to determine codebooks corresponding to the determined subrates.

In some examples, the system further comprises: a function determiner operable to determine a function of a channel matrix, wherein the function of the channel matrix is decomposed rather than the channel matrix.

In some examples, the system further comprises: a splitter operable to split a rate of the at least one message into the determined subrates corresponding to submessages; an encoder operable to encode the submessages, wherein the codebooks correspond to the determined subrates; and a multiplier operable to multiply a resulting unitary matrix or a function thereof by the encoded submessages to derive the elements for transmission.

In some of these examples, the system further comprises a dirty paper coder operable to apply dirty paper coding; wherein the multiplier is operable to multiply the resulting unitary matrix or the function thereof by the submessages which had been encoded using the codebooks and the dirty paper coding, and wherein the resulting unitary matrix which is multiplied or whose function is multiplied corresponds to a MIMO channel via which the elements are to be transmitted to the relay node.

In some examples, the system further comprises: a multiplier operable to multiply elements which were received, by a unitary matrix resulting from the decomposition or by a function thereof; and a decoder operable to decode.

In some of these examples the decoder includes a successive decoder operable to apply successive decoding based on at least one resulting triangular matrix and codebooks corresponding to the determined subrates.

In some of these examples, the decoder includes a structured physical layer coding PNC decoder operable to perform structured PNC decoding. In some cases of these examples, the system further comprises: an encoder operable to encode results of the PNC decoding.

In some of these examples, the system further comprises: a combiner operable to combine results of the decoding.

### BRIEF DESCRIPTION OF THE DRAWINGS

In order to understand the subject matter and to see how it may be carried out in practice, examples will be described, with reference to the accompanying drawings, in which:

FIG. 1 is a block diagram illustrating an example of a general communication network, in accordance with the presently disclosed subject matter;

FIG. 2 is a block diagram illustrating an example of a communication network for transmitting elements relating at least to a common message, in accordance with the presently disclosed subject matter;

FIG. 3 is a block diagram illustrating an example of a communication network for transmitting elements relating to private messages to one another via a relay node, in accordance with the presently disclosed subject matter;

FIG. 4A is a block diagram illustrating an example of a communication network with unknown channel or signal to noise ratio, in accordance with the presently disclosed subject matter;

FIG. 4B is a block diagram illustrating an example of a communication network where a transmitting node transmits to one or more receiving nodes, partly via at least one relay node, in accordance with the presently disclosed subject matter;

FIG. 5 is a flowchart of an example of a method of preparing for message communication, in accordance with the presently disclosed subject matter;

FIG. 6 is a block diagram of an example of a preparation system at a node, in accordance with the presently disclosed subject matter;

FIG. 7 is a flowchart of an example of a transmission method performed by a transmitting node, in accordance with the presently disclosed subject matter;

FIG. 8 is a block diagram of an example of a transmission system at a transmitting node, in accordance with the presently disclosed subject matter;

FIG. 9 is a flowchart of an example of a reception method performed by a receiving node, in accordance with the presently disclosed subject matter;

FIG. 10 is a block diagram of an example of a receiving system at a receiving node, in accordance with the presently disclosed subject matter;

FIG. 11 is a flowchart of an example of a private message exchange method performed by a terminating node, in accordance with the presently disclosed subject matter;

FIG. 12 is a block diagram of an example of a private message exchange system at a terminating node, in accordance with the presently disclosed subject matter;

FIG. 13 is a flowchart of an example of a relay method performed by a relay node, in accordance with the presently disclosed subject matter;

FIG. 14 is a block diagram of an example of a relay system at a relay node, in accordance with the presently disclosed subject matter;

FIG. 15 is a flowchart of an example of a transmission method performed by a transmitting node, in accordance with the presently disclosed subject matter;

FIG. 16 is a block diagram of an example of a transmission system at a transmitting node, in accordance with the presently disclosed subject matter;

FIG. 17 is a flowchart of an example of a relay method performed by a relay node, in accordance with the presently disclosed subject matter;

FIG. 18 is a block diagram of an example of a relay system at a relay node, in accordance with the presently disclosed subject matter;

FIG. 19 is a flowchart of an example of a receiving method performed by a receiving node, in accordance with the presently disclosed subject matter;

FIG. 20 is a block diagram of an example of receiving system at a receiving node, in accordance with the presently disclosed subject matter;

FIG. 21a illustrates an example of interleaving of transmitted vectors, in accordance with the presently disclosed subject matter;

FIG. 21b illustrates another example of interleaving of transmitted vectors, in accordance with the presently disclosed subject matter; and

FIG. 22 illustrated a system at a node operable to transmit, exchange, relay and/or receive, in accordance with the presently disclosed subject matter.

### DETAILED DESCRIPTION OF THE DRAWINGS

### A. Introduction

Described herein are some examples of systems and methods for communication networks including multiple-input multiple output MIMO channels. In these examples, based on a novel decomposition of two or more channel matrices or functions thereof, a MIMO channel may be treated as a plurality of parallel scalar additive white Gaussian noise (AWGN) channels.

In the following detailed description, numerous specific details are set forth in order to provide a thorough understanding of the subject matter. However, it will be understood by those skilled in the art that some examples of the subject matter may be practiced without these specific details. In other instances, well-known stages, methods, modules, and systems have not been described in detail so as not to obscure the description.

As used herein, the phrase “for example,” “such as”, “for instance” and variants thereof describe non-limiting examples of the subject matter.

The terms “SISO channels” and “scalar channels” are used interchangeably. The terms “SISO codes” and “scalar codes” are used herein interchangeably. Similarly variants thereof are used interchangeably herein.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “decomposing”, “transmitting”, “encoding”, “multiplying”, “applying” “splitting”, “combining”, “forming”, “decoding”, “applying”, “transmitting”, “receiving”, “sending”, “determining”, “figuring out”, “interleaving”, “reversing”, or the like, refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

### B. Overview of the Communication Network

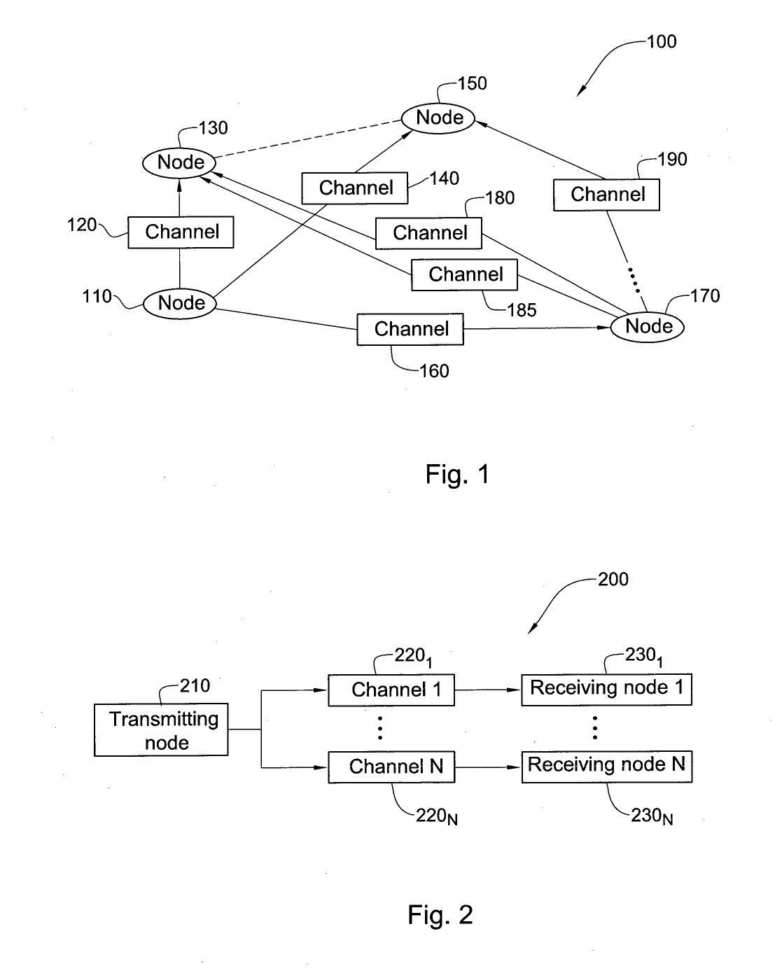

Referring now to the drawings, FIG. 1 is a block diagram illustrating an example of a general communication network 100, in accordance with the presently disclosed subject matter.

In the example illustrated in FIG. 1, a node 110 is operable to transmit via a MIMO channel 120 to a node 130. Node 110 is additionally or alternatively operable to transmit via a MIMO channel 140 to a node 150. Node 110 is additionally or alternatively operable to transmit via a MIMO channel 160 to a node 170. Node 170 is operable to transmit via a MIMO channel 190 to node 150. Node 170 is additionally or alternatively operable to transmit via a MIMO channel 180 to node 130. Node 170 is additionally or alternatively operable to transmit via a MIMO channel 185 to node 130. In some cases, one or more of MIMO channels 120, 140, 160, 180, 185 and/or 190, may also convey messages in the opposite direction (e.g. from node 150 to node 170, from node 170 to node 110, etc). Additionally or alternatively, in some cases network 100 may include one or more additional MIMO channels for conveying messages in the opposite direction (e.g. from node 150 to node 170, from node 170 to node 110, etc).

In other examples, network 100 may include more, fewer and/or different nodes than illustrated in FIG. 1, and/or network 100 may include more, fewer and/or different MIMO channels in addition than illustrated in FIG. 1.

In some cases at least two MIMO channel matrices are to be considered For instance, assume a scenario where elements relating to a common message are being transmitted by a particular node to two or more other nodes, via two or more MIMO channels. Referring to FIG. 1, node 110 may transmit elements relating to the common message via channel 120 to node 130 and via channel 140 to node 150. Optionally, node 110 may also transmit elements relating to one or more private messages to node 130 and/or 150. FIG. 2 is a block diagram illustrating an example of a communication network 200 for transmitting elements relating at least to a common message, in accordance with the presently disclosed subject matter. In FIG. 2 a transmitting node 210 transmits via a plurality of MIMO channels 220 to a plurality of receiving nodes 230, respectively.

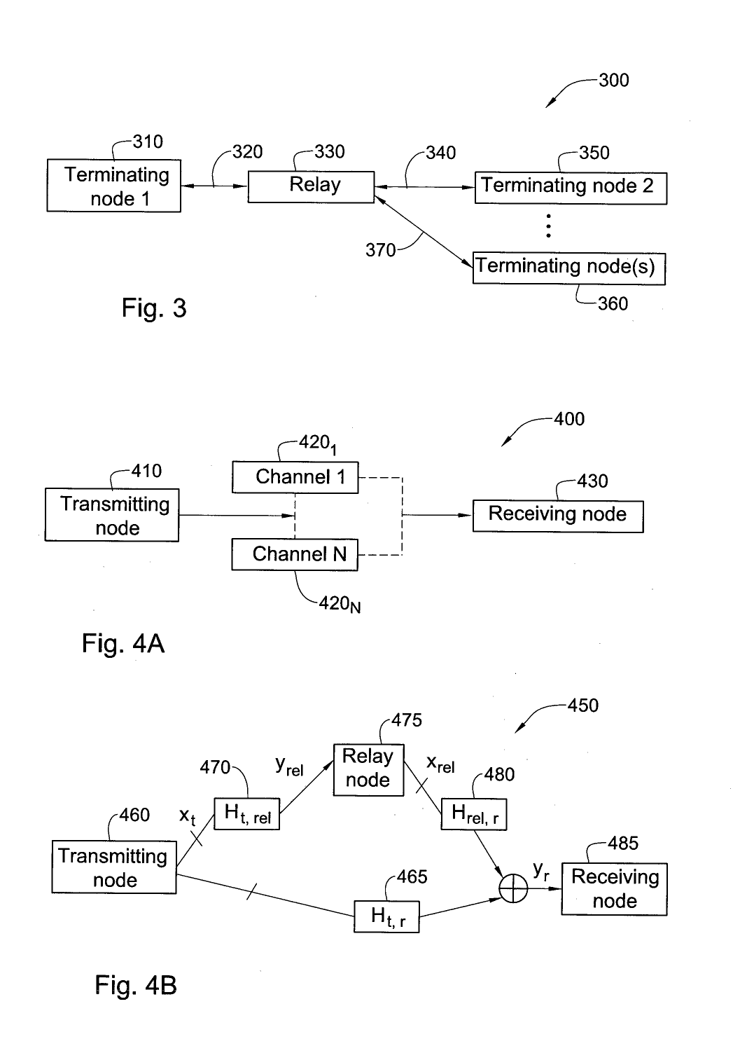

Additionally or alternatively, in another instance where at least two MIMO channel matrices are to be considered assume a scenario where two or more nodes may transmit elements relating to private messages to one another via another node, and therefore the other node receives via two or more channels elements relating to the private messages. Referring again to FIG. 1, and assuming that node 150 is a relay node, node 150 may receive elements relating to a private message from node 170 via channel 190, and may receive elements relating to another private message from node 110 via channel 140. In some cases, channel 190 and/or 140 may also convey elements relating to the private messages back to node 170 and/or 110 respectively, or there may be separate channel(s) for conveying to node 170 and/or 110. FIG. 3 is a block diagram illustrating an example of a communication network 300 for transmitting elements relating to private messages to one another via a relay node, in accordance with the presently disclosed subject matter. In the example illustrated in FIG. 3, a terminating node 310 transmits to and receives from relay node 330 via MIMO channel 320. Additionally, a terminating node 350 transmits to and receives from relay node 330 via MIMO channel 340. Optionally, assuming more than two MIMO channels, an additional one or more terminating node(s) 360 may transmit to and receive from relay node 330 via an additional one or more MIMO channel(s) 370 respectively. In other examples, any of the MIMO channels between a terminating node and relay node 330 may be one way, with transmission in the other direction via a different channel.

In another instance, additionally or alternatively, assume a scenario where a node may potentially transmit elements relating to a message via any one of a plurality of MIMO channels, where the transmitting channel is not known to the transmitting node in advance or where the channel matrix is known but the signal to noise ratio is unknown (Herein, reference to “unknown noise”, reference to “unknown signal to noise” and variants thereof are used interchangeably). Referring to FIG. 1, node 170 may transmit elements relating to a message via channel 180 or via channel 185 to node 130, and may not know in advance which channel will be used. Additionally or alternatively node 170 may transmit elements relating to a message via channel 180 which has unknown signal to noise ratio SNR to node 130. FIG. 4A is a block diagram illustrating an example of a communication network 400 with unknown channel or signal to noise ratio, in accordance with the presently disclosed subject matter. A transmitting node 410 may transmits via any one of a plurality of MIMO channels 420 to a receiving node 430, where the transmitting channel is not known in advance to transmitting node 410. Additionally or alternatively, transmitting node 410 may know in advance that transmission will be via a certain MIMO channel 420 to a receiving node 430 but the SNR of the channel may not be known.

In another instance, additionally or alternatively, assume a scenario where a transmitting node transmits to one or more receiving nodes, partly via at least one relay node. Referring to FIG. 1, and assuming in this instance that node 170 is a relay node, node 110 may transmit elements relating to a message via channel 120 to receiving node 130 and may also transmit elements relating to the message via channel 160 to relay node 170 and then relay node 170 may transmit elements relating to the message via channel 180 to receiving node 130. As will be explained further below, if relay node 170 functions in the half-duplex setting where at each time instant the relay may either receive or transmit but not both simultaneously, then the three MIMO channels can be thought of alternatively as two MIMO channels with the first MIMO channel 160 (transferring elements between transmitting node 110 and relay node 170) and the second MIMO channel a function of channel 120 and 160 (where transmitting node and relay node may be considered as a single node transmitting coherently over an “effective” channel which is effectively a single MIMO channel.) FIG. 4B is a block diagram illustrating an example of a communication network 450 where a transmitting node transmits to one or more receiving nodes, partly via at least one relay node, in accordance with the presently disclosed subject matter. A transmitting node 460 may transmit via channel 470 to a relay node 475. Relay node 475 may transmit via a channel 480 to a receiving node 485. Transmitting node 460 may also transmit via a channel 465 to receiving node 485.

The disclosure does not limit the scenarios to those described above which are just examples. The decompositions, methods, method stages, systems, and/or system modules which will be described below may be relevant to other scenario(s) in addition to or instead of the scenarios above.

### C. The Novel Matrix Decomposition

### 1. Decomposition of Two Matrices

In some examples of decomposition, two matrices (e.g. channel matrice(s) and/or function(s) thereof) may be decomposed as follows

A₁=U₁D₁V^{†}

A₂=U₂D₂V^{†} (2)

where i=1, 2, Dᵢ is an upper triangular matrix, Uᵢ is a unitary matrix and V is a unitary matrix. If Aᵢ has k columns, then the corresponding Dᵢ resulting from the decomposition will also have k columns each. Note that the matrices D₁ and D₂ need not be square, and also that they need not have the same number of rows. Since D₁ and D₂ are triangular matrices, the decomposition in accordance with equation (2) is referred to below as an example of a “joint triangularization”.

By appropriately choosing the matrices Uᵢ and V, we can ensure that the diagonal elements of the resulting triangular matrices will satisfy certain desirable properties.

In one example of the decomposition in accordance with equation 2, assume that the two matrices A₁ and A₂ have equal absolute values of determinants, and therefore the resulting triangular matrices from the decomposition will have equal diagonals (i.e. in this example the desirable property is equal diagonals).

Proof of the decomposition in accordance with equation 2, for the case of triangular matrices with equal diagonals, is provided in theorem 1 of the Appendix.

In order to demonstrate the decomposition, consider the following two matrices:

$${A}_{1} = [ \begin{matrix}- 0.0586 & - 0.1539 & - 0.6987 \\ - 0.2981 & 1.4067 & - 0.2958 \\ 0.6398 & 1.4651 & - 0.5790\end{matrix} ] ; det ( {A}_{1} ) = 1$$

$${A}_{2} = [ \begin{matrix}- 0.9816 & - 0.6456 & 0.1200 \\ - 0.8874 & 1.1902 & 0.1561 \\ 0.7027 & - 0.5220 & - 0.6866\end{matrix} ] ; det ( {A}_{2} ) = 1 = det ( {A}_{1} )$$

The decomposition may result in

$${D}_{1} = [ \begin{matrix}1.1601 & 1.3770 & 0.0117 \\ 0 & 1.3855 & 0.0168 \\ 0 & 0 & 0.6221\end{matrix} ] ;$$

$${D}_{2} = [ \begin{matrix}1.1601 & 0.6328 & - 0.8988 \\ 0 & 1.3855 & 0.0045 \\ 0 & 0 & 0.6221\end{matrix} ]$$

$${U}_{1} = [ \begin{matrix}- 0.4805 & 06265 & 0.6137 \\ - 0.2423 & - 0.7673 & 0.5937 \\ - 0.8429 & - 0.1366 & - 0.5205\end{matrix} ] ;$$

$${U}_{2} = [ \begin{matrix}0.5541 & 0.6472 & 0.5236 \\ 0.3594 & - 0.7533 & 0.5507 \\ - 0.7509 & 0.1170 & 0.6522\end{matrix} ]$$

$$V = [ \begin{matrix}- 0.4717 & 0.0861 & - 0.8775 \\ - 0.1160 & - 0.9926 & - 0.0351 \\ 0.8741 & - 0.0852 & - 0.4782\end{matrix} ]$$

In another of these examples, assume that the absolute values of the determinants of A₁ and A₂ are not equal and therefore the diagonals of the resulting triangular matrices will not necessarily be equal. In this example, there may be different ratios between corresponding values on the diagonals of the resulting triangular matrices. In some cases of this example, the elements on the diagonal of D₁ may be greater than the corresponding diagonal value in D₂ (or vice versa) but there will be a constant ratio between corresponding diagonal elements (i.e. in these cases, the desirable property is a constant ratio).

Continuing with these cases, for the following matrices:

$${A}_{1} = [ \begin{matrix}- 0.0757 & - 0.1989 & - 0.8916 \\ - 0.3853 & 1.8184 & - 0.3823 \\ 0.8271 & 1.893 & - 0.7484\end{matrix} ] ; det ( {A}_{1} ) = 2.16$$

$${A}_{2} = [ \begin{matrix}- 0.9684 & - 0.6368 & 0.1184 \\ - 0.8754 & 1.1741 & 0.1540 \\ 0.6932 & - 0.5150 & - 0.6773\end{matrix} ] ; det ( {A}_{2} ) = 0.96 .$$

The decomposition may result in:

$${D}_{1} = [ \begin{matrix}1.4996 & 1.7799 & 0.0152 \\ 0 & 1.7910 & 0.0217 \\ 0 & 0 & 0.8042\end{matrix} ] ;$$

$${D}_{2} = [ \begin{matrix}1.1444 & - 0.6242 & 0.8866 \\ 0 & 1.3668 & 0.0044 \\ 0 & 0 & 0.6137\end{matrix} ]$$

$${U}_{1} = [ \begin{matrix}- 0.4805 & 06265 & 0.6137 \\ - 0.2423 & - 0.7673 & 0.5937 \\ - 0.8429 & - 0.1366 & - 0.5205\end{matrix} ] ;$$

$${U}_{2} = [ \begin{matrix}0.5541 & 0.6472 & 0.5236 \\ 0.3594 & - 0.7533 & 0.5507 \\ - 0.7509 & 0.1170 & 0.6522\end{matrix} ]$$

$$V = [ \begin{matrix}- 0.4717 & 0.0861 & - 0.8775 \\ - 0.1160 & - 0.9926 & - 0.0351 \\ 0.8741 & - 0.0852 & - 0.4782\end{matrix} ]$$

In other cases of this example, the elements on the diagonal of D₁ may be greater than the corresponding diagonal value in D₂ (or vice versa) and there will not necessarily be a constant ratio between corresponding diagonal elements. In these cases, the desirable property depends on the application. Continuing with these cases, for the following (same) matrices:

$${A}_{1} = [ \begin{matrix}- 0.0757 & - 0.1989 & - 0.8916 \\ - 0.3853 & 1.8184 & - 0.3823 \\ 0.8271 & 1.893 & - 0.7484\end{matrix} ] ; det ( {A}_{1} ) = 2.16$$

$${A}_{2} = [ \begin{matrix}- 0.9684 & - 0.6368 & 0.1184 \\ - 0.8754 & 1.1741 & 0.1540 \\ 0.6932 & - 0.5150 & - 0.6773\end{matrix} ] ; det ( {A}_{2} ) = 0.96$$

The decomposition may result in

$${D}_{1} = [ \begin{matrix}0.9000 & 0.2110 & 1.0358 \\ 0 & 1.2000 & 1.3802 \\ 0 & 0 & 2.0000\end{matrix} ] ;$$

$${D}_{2} = [ \begin{matrix}0.8000 & 0.7919 & 0.1771 \\ 0 & 1.2000 & - 0.9959 \\ 0 & 0 & 1.0000\end{matrix} ]$$

$${U}_{1} = [ \begin{matrix}- 0.7727 & 0.6335 & - 0.0400 \\ - 0.0682 & - 0.0203 & 0.9975 \\ 0.6311 & 0.7735 & 0.0589\end{matrix} ] ;$$

$${U}_{2} = [ \begin{matrix}- 0.9563 & 0.0165 & - 0.2918 \\ - 0.2683 & - 0.4459 & 0.8539 \\ - 0.1160 & 0.8949 & 0.4308\end{matrix} ]$$

$$V = [ \begin{matrix}0.7036 & 0.6909 & - 0.1663 \\ 0.2548 & - 0.0268 & 0.9666 \\ 0.6633 & - 0.7225 & - 0.1949\end{matrix} ]$$

For simplicity's sake, the matrices presented above include three columns and three rows. However in other examples, the matrices may include fewer or more columns and/or fewer or more rows. It is noted that since a MIMO channel includes a plurality of transmitting antennas and a plurality of receiving antennas, a MIMO channel matrix may have the number of columns greater than or equal to two and the number of rows is greater than or equal to two.

2. Decomposition of More than Two Matrices

In some examples of decomposition, three matrices A₁, A₂, A₃ (e.g. channel matrice(s) and/or function(s) thereof) may be decomposed as follows

[symbol]

₁^{†}A₁ [symbol] = [symbol] ₁

[symbol]

₂^{†}A₂ [symbol] = [symbol] ₂

[symbol]

₃^{†}A₃ [symbol] = [symbol] ₃, (3)

where [symbol] ₁, [symbol] ₂, [symbol] ₃, [symbol] are matrices with orthonormal columns, and [symbol] ₁, [symbol] ₂, [symbol] ₃ are upper-triangular matrices with diagonals that have one or more desirable properties. However, as opposed to the decomposition of two matrices, in this case the matrices [symbol] ᵢ and [symbol] are not square matrices, but rather have more rows than columns. Since [symbol] ₁, [symbol] ₂, [symbol] ₃ are triangular matrices, the decomposition in accordance with equation (3) is referred to below as an example of a “joint triangularization”. Proof of this decomposition for the case of triangular matrices with equal diagonals is shown in theorems 3 and 4 of the appendix.

In examples with more than three matrices, an appropriate decomposition (allowing joint triangularization) may be derived by generalizing the decompositions presented in equations 2 and 3.

In other examples, two or more channel matrices or functions thereof may be decomposed (jointly triangularized) with equal, nearly equal, or not necessarily equal diagonals using any other appropriate decomposition and/or method, such as numerical methods.

### D. Network Model

Assuming that any one node receives elements via a single (point to point) Gaussian MIMO channel at a time, each Gaussian MIMO channel may be given by

yᵢ=Hᵢx+nᵢ, i=1,2, (1A)

where x is the input to the i-th channel, and i may also equal higher numbers up to the number of channels. Equation 1A may be relevant to broadcast mode, or for any other appropriate mode.

The transmit signal x may be subject to an average total power constraint E[x^{†}x]≦P. Alternatively, one can consider an input covariance constraint C_{X}=E[xx^{†}]<C, where C₁<C₂ means that the matrix (C₂−C₁) is positive semi-definite and C^{†} denotes the Hermitian transpose of C.

Assuming instead that a receiving node receives elements via a plurality of MIMO channels at a time, equation 1A may be adapted to the following equation

yₒ=Σ(Hᵢxᵢ)+n₀ (1B)

where o may be 1, and possibly higher numbers if there is more than one receiving node. Equation 1B may be relevant to multicast (MAC) mode, or for any other appropriate mode.

In equation 1A or 1B, for instance the transmit signal x (or xᵢ) may be the complex-valued channel input vector of size Nₜ×1, yᵢ or yₒ may be the received vectors of sizes Nᵣⁱ×1, Hᵢ may be the Nᵣⁱ×Nₜ complex channel matrices, nᵢ may be mutually-independent identically-distributed circulary-symmetric complex Gaussian random vectors of sizes Nᵣⁱ, i.e., nᵢ˜ [symbol] (0,I_{N}_{ᵣ}_{ⁱ}), and nₒ may be the sum of noises for the various receiving channels.

The matrix Hᵢ for a particular channel, may include values representing all possible paths between transmitting antennas and receiving antennas for that channelᵢ. As used in the disclosure herein, an antenna may include any module that allows transmission to or reception from a communication channel.

When two or more MIMO channel matrices are relevant, the channel matrices (or a subset of the channel matrices), or functions thereof, may be decomposed simultaneously in order to simplify calculations including the channel matrices or functions thereof. The disclosure does not limit the decomposition but for the sake of further illustration to the reader some examples are presented herein. For instance, if the decomposition is for two channel matrices or function(s) thereof then the decomposition of equation (2) may be applied. In another instance, if the decomposition is for three channel matrices or function(s) thereof then the decomposition of equation (3) may be applied. However in other instances any other suitable decomposition may be used.

If more than one possible decomposition is possible then the decomposer at a particular node may select which decomposition to perform or may be informed of the desired decomposition by a decomposer of another node.

### Applications

It is noted that the disclosure does not limit the applications for which joint decomposition of MIMO channel matrices or functions thereof is desirable and that other applications besides those explicitly described below may benefit from joint decomposition, mutatis mutandis.

Bearing the above in mind, now will be described various examples of communication methods and systems in accordance with the currently disclosed subject matter. Depending on the example, a communication method in accordance with the currently disclosed subject matter may include part or all of any one method described below, a combination of two or more methods or parts thereof described below, etc. Similarly, depending on the example, a communication system in accordance with the currently disclosed subject matter may include part or all of any one system described below, a combination of two or more systems or parts thereof described below, etc. Depending on the example, a communication method in accordance with the currently disclosed subject matter may additionally or alternatively include stage(s) not described below, and/or a communication system in accordance with the currently disclosed subject matter may additionally or alternatively include module(s) not described below.

Typically, although not necessarily, channel conditions change over time, and therefore channel matrices may also change over time. Therefore, in some cases, the decomposition of channel matrices or functions thereof may need to be performed at relevant nodes whenever channel conditions have changed since the last decomposition (or during initialization of a channel), and communication of message(s) is desired. Optionally the decomposition may be repeated even if channel conditions have not changed, or without first determining whether or not channel conditions have been changed.

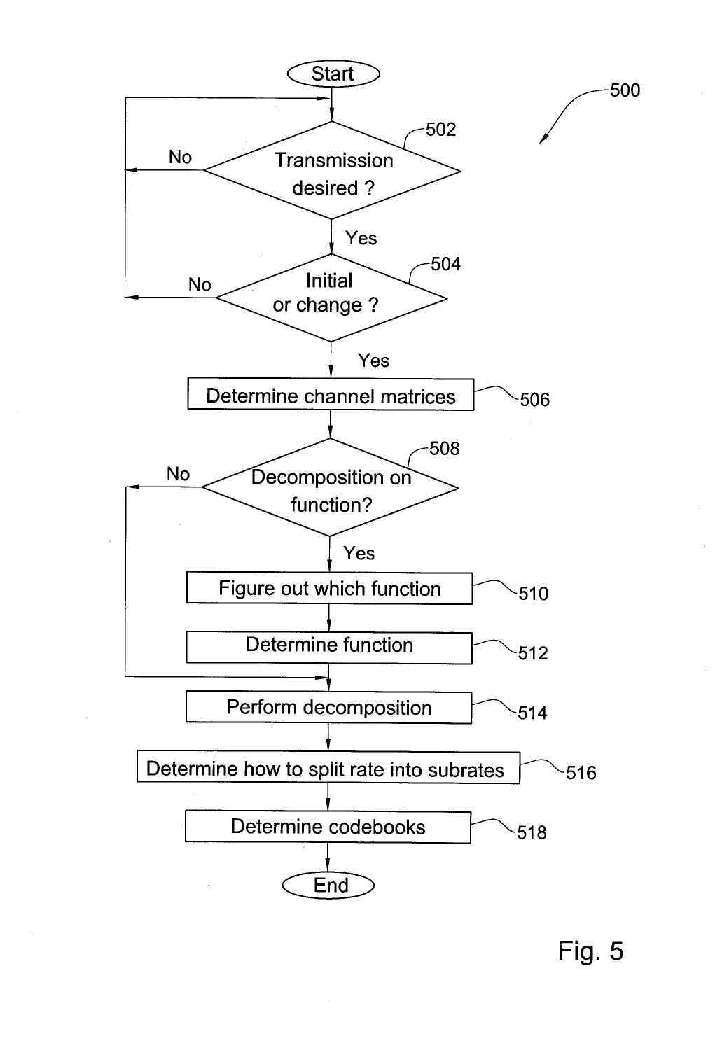

FIG. 5 is a flowchart of an example of a method 500 of preparing for message communication, in accordance with the presently disclosed subject matter. For instance, method 500 may be executed at a node prior to transmission or reception.

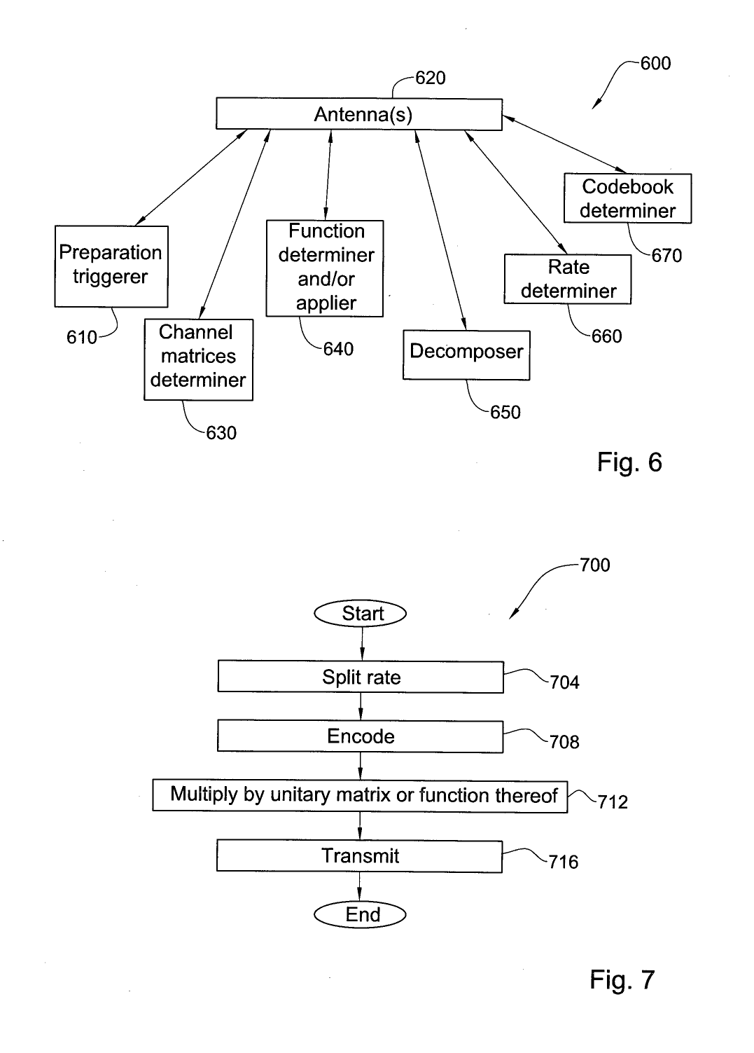

FIG. 6 is a block diagram of an example of a preparation system 600 at a node, in accordance with the presently disclosed subject matter. In the illustrated example, preparation system 600 includes one or more decomposer module(s) 650 and/or one or more rate determiner module(s) 660. Preparation system 600 may also optionally include any of the following modules: one or more antenna(s) module(s) 620, one or more preparation triggerer module(s) 610, one or more channel matrices determiner module(s) 630, one or more function determiner and/or applier module(s) 640, and/or one or more codebook determiner module(s) 670.

The disclosure does not limit the number and/or type of (involved) nodes which may execute part or all of preparation method 500 and/or which may include part or all of preparation system 600. However, for further illustration to the reader, some examples will now be presented. For instance, the (involved) node which may execute may be a node operable to transmit elements relating at least to a common message over at least two MIMO channels for instance to at least two receiving nodes, any receiving node operable to receive elements relating at least to such a common message, a node operable to transmit elements relating to at least one message over an unknown MIMO channel out of two or more possible MIMO channels to a receiving node, a receiving node operable to receive elements relating to such at least one message, a node operable to transmit elements relating to at least one message over a known MIMO channel with unknown noise to a receiving node, a receiving node operable to receive elements relating to such at least one message, a node operable to transmit elements relating to at least one message to a receiving node and to a relay node, a relay node operable to receive such elements and transmit element relating to the at least one message to a receiving node, and a receiving node operable to receive elements relating to the at least one message from the transmitting node and relay node; a relay node operable to receive elements relating to private messages via at least two MIMO channels from at least two terminating nodes, and/or any terminating node operable to transmit elements relating to such a private message to a relay.

In the illustrated example, in stage 502 preparation system 600 at an involved node, for instance preparation triggerer module 610, determines if message communication is currently desirable, where message communication may include transmission or reception of elements relating to at least one message. If the node will be transmitting, then preparation triggerer 610 may know that there is a waiting message and may inform any receiving node(s) via antenna(s) 620. If the node will be receiving, then preparation triggerer 610 may be informed via antenna(s) 620 of an upcoming transmission. If communication is not currently desired (no to stage 502), then in the illustrated example preparation system 600 waits until communication is desired (stays at stage 502). If communication is currently desirable (yes to stage 502), then in the illustrated example method 500 continues to stage 504.

In the illustrated example, in stage 504, preparation system 600 at an involved node, for instance preparation triggerer 610 determines whether or not MIMO channel conditions have changed, or whether or not MIMO channel(s) have been put into service (initialized). If there has been no change or initialization (no to stage 504), then in the illustrated example method 500 returns to stage 502 until the next transmission or reception is desired. In this case, any transmission or reception methods described below (e.g. 700, 900, 1100, 1300, 1500, 1700, 1900, etc.) may proceed in accordance with a previous iteration of method 500. If instead there has been a change or initialization (yes to stage 504), then in the illustrated example method 500 continues to stage 506. For instance, the preparation triggerer at a node designated for receiving may notice a change in channel conditions and may inform a preparation triggerer at a node designated for transmitting and any other preparation triggerer(s) at any other involved node(s).

The disclosure does not limit the MIMO channel(s) which may be initialized or whose conditions may have changed but for the sake of further illustration to the reader, some examples are now provided. In the case of a common message whose elements will be transmitted via at least two MIMO channels, the MIMO channel(s) whose conditions may have changed or which may have been initialized may refer to any of these channels. In the case of private messages whose elements will be transmitted to a relay node via at least two MIMO channels, the MIMO channel(s) whose conditions may have changed or which may have been initialized may refer any of these channels. In the case of a message whose elements will be transmitted via an unknown one of at least two possible MIMO channels, the MIMO channel(s) whose conditions may have changed or which may have been initialized may refer to any of these possible channels. In the case of a message whose elements will be transmitted via a MIMO channel with unknown noise, the MIMO channel whose conditions may have changed or which may have been initialized may refer to that channel. In the case of a message which will be transmitted partly via at least one relay node to at least one receiving node, then the MIMO channel(s) whose conditions may have changed or which may have been initialized may refer to any of the following: MIMO channel(s) between a transmitting node and a relay node, MIMO channel(s) between a relay node and a receiving node, and/or MIMO channel(s) between a transmitting node and a receiving node.

Alternatively, stage 504 may be omitted if each time transmission is desired (yes to stage 502), method 500 proceeds directly to stage 506.

In the illustrated example, in stage 506 preparation system 600 at an involved node, for instance channel matrices determiner 630 determines the MIMO channel matrices. For instance, a channel matrices determiner at a particular node may detect anyone of the values of a MIMO channel matrix independently, or may be informed of the value by a channel matrices determiner at another node. Therefore in some cases is assumed full knowledge of all channel matrices at all involved nodes, also known as “closed loop”.

The disclosure does not limit the determined MIMO channel matrices, but for the sake of further illustration, some examples are now given. In the case of a common message whose elements will be transmitted via at least two MIMO channels, the MIMO channel matrices may refer to matrices corresponding to those MIMO channels. In the case of private messages whose elements will be transmitted to a relay node via at least two MIMO channels, the MIMO channel matrices may refer to matrices corresponding to those channels. In the case of a message whose elements will be transmitted via an unknown one of at least two possible MIMO channels, the MIMO channel matrices may refer to matrices corresponding to those possible MIMO channels. In the case of a message whose elements will be transmitted via a MIMO channel with unknown noise, the MIMO channel matrices may refer to matrices corresponding respectively to the channel under different possible noise conditions. In the case of a message whose elements will be transmitted to a relay node (and then in turn to a receiving node) and to a receiving node, the MIMO channel matrices may refer to matrices corresponding to any of the following: MIMO channel(s) between a transmitting node and a relay node, MIMO channel(s) between a relay node and a receiving node, and/or MIMO channel(s) between a transmitting node and a receiving node.

In the illustrated example, in stage 508 preparation system 600 at an involved node, for instance a function determiner and/or applier 640, determines whether or not the decomposition will be performed on the MIMO channel matrices or for at least one of the MIMO channel matrices on a function of the MIMO channel matrix. In some cases, it may be desirable to decompose function(s) of one or more of the MIMO channel matrices instead of the channel matrice(s). If the decomposition will be performed only on channel matrices (no to stage 508) then in the illustrated example method 500 skips to stage 514. If the decomposition will be performed for at least one of the channel matrices, on a function of the channel matrix, (yes to stage 508) then in the illustrated example in stage 510 preparation system 600 at an involved node, say function determiner and/or applier 640 figures out which function will be decomposed. For instance, function determiner and/or applier at a particular node may select the function or may be informed of the function selected by a function determiner and/or applier at another node. If the function(s) is/are instead known a-priori, for instance because the same function(s) is/are always computed then stage 510 may be omitted.

In the illustrated example in stage 512 function(s) of the channel matrice(s) is/are determined (e.g. computed) by preparation system 600 at an involved node, say by function determiner and/or applier 640.

The disclosure does not limit the function(s) that may be determined but for the further understanding of the reader, some examples are presented below.

For example, some possible functions of MIMO channel matrices may include augmented matrices. The disclosure does not limit the usage of augmented matrices, but for further illustration to the reader, some examples are presented further below. For instance, in cases with a better/channels (incremental redundancy), more than two receiving nodes, half duplex relay, etc, a function may sometime include augmented matrices. Continuing with these cases, one possible function relating to incremental redundancy includes augmented channel matrices which are block diagonal, where each block represents a MIMO channel matrix at a certain time instance.

Additionally or alternatively, for example, some possible functions may relate to a product of a channel matrix and a factor, S (e.g. where S may include a matrix, etc)

For instance, in some cases the function may take into account the covariance matrix. Continuing with this instance in some of these cases if S=\sqrt{Cₓ} then multiplying the channel matrices by S yields the functions

$$⌊ \begin{matrix}{H}_{i} \sqrt{{C}_{x}} \\ I\end{matrix} ⌋ .$$

Additionally or alternatively, for instance the function may in some cases take into account beamforming. Continuing with this instance, in some of these cases S may relate to a beamforming matrix or matrices. Optionally, power constraints may be absorbed in the beamforming matrices. Additionally or alternatively, for example, other possible functions (which may or not result from multiplication by S) may relate any of the following inter-alia: pre or post processing of message(s), changing matrices to have equal or non-equal determinants, private message(s) being transmitted in addition to a common message, etc.

Additionally or alternatively, for example, other possible functions may result from operations which include the development of augmented matrices (e.g., half duplex relay, better/worse channels (incremental redundancy), more than two receiving nodes etc), and other operations such as multiplication by S. For instance, assuming that one wants to take the covariance matrix into account, if S=\sqrt{Cₓ} then functions resulting from augmented matrices and multiplication by S may include the matrices

$$⌊ \begin{matrix}{H}_{i} \sqrt{{C}_{x}} \\ I\end{matrix} ⌋$$

Some possible functions are described in more detail further below with reference to specific applications.

In the illustrated example, in stage 514, joint decomposition of the MIMO channel matrices (e.g. as determined in stage 506) or of any function(s) thereof (e.g. as determined in stage 512) is performed by preparation system 600 at an involved node, for instance by decomposer 650. The decomposition may result inter-alia in triangular matrices (thus the term “joint triangularization”) and unitary matrices. In some cases, where the decomposition is applied directly the channel matrices, the scheme may be optimal in the high SNR limit only but in other cases may be optimal even for general SNR. It is noted that in many methods such as those described herein, diagonal matrices are not necessary and having triangular matrices result may be sufficient for communication. As explained elsewhere herein, the disclosure does not limit the decomposition used but examples of possible decompositions are provided elsewhere herein.

In the illustrated example, in stage 516, preparation system 600 at an involved node, for instance rate determiner 660 determines how to split the rate for the at least one message to be communicated into subrates corresponding to submessages, based on the triangular matrices received from the decomposition.

For instance, assuming that

$${D}_{1} = ⌊ \begin{matrix}1.1601 & 1.3770 & 0.0117 \\ 0 & 1.3855 & 0.0168 \\ 0 & 0 & 0.6221\end{matrix} ⌋ ,$$

the rate may be split among submessages in conformance with the sizes of the corresponding values in the diagonal. In this instance, the second submessage (corresponding to value 1.3855) would be allocated a higher subrate than the first submessage (corresponding to value of 1.1601), which would in turn be allocated a higher subrate than the third submessage (corresponding to value of 0.6221).

It is noted that it is possible in some cases for two or more values in the diagonal to be equal. If there is more than one possible way to split the rate among subrates then the rate determiner at a particular node may select the way to split the rate or may be informed of the desired split selected by a rate determiner of another node.

In some cases, where it is assumed that codebooks of equal power

$$\frac{1}{k}$$

win be used, each subrate may be defined as

$${R}_{j} = log \frac{{d}_{j}^{2}}{k}$$

Where k is the number of columns in the matrix which will be decomposed (i.e. either the channel matrix or function thereof) and dⱼ is the value of a diagonal element which corresponds to the subrate in the associated triangular matrix. However in other cases, the subrates may be different, for instance if the codebooks are of unequal power.

In some cases, the determination at a particular node of how to split into subrates based on the diagonal values may be performed by actual calculation of the subrates or by receiving the subrates or other information from another node. In some cases, the determination of how to split into subrates may be based on other data in addition to or instead of being based on the diagonal values.

In some examples, stage 516 may be omitted at a particular involved node. For example in some cases where knowledge of the subrates is not required at a particular node, stage 516 may not necessarily be performed by that node.

In the illustrated example, in stage 518, preparation system 600 at the involved node, for instance codebook determiner 670 determines codebooks corresponding to the determined subrates. For instance, a collection of codebooks, from which selection may be made, may be available in local or remote memory (the term “memory” should be understood to refer to any module for storing data for the short and/or long term, locally and/or remote). In this instance, codebook determiner 670 may select the codebooks from the collection based on the subrates determined in stage 516. If different appropriate codebooks may be selected which correspond to a subrate determined in stage 516, then the codebook determiner at a particular node may select from among the different appropriate codebooks or may be informed of the desirable codebooks by a codebook selector of another node.

Stage 518 may be omitted if the same codebooks are always used and therefore determination is unnecessary, for instance because these always used codebooks include sufficient rate options and therefore necessarily correspond to the determined subrates. Alternatively or additionally stage 518 may be omitted at a particular involved node. For instance, in some cases where decoding does not require codebooks corresponding to determined subrates, stage 518 may not necessarily be performed at the node that would be performing the decoding.

In terms of the codebooks selected for use in stage 518 or always used, it is noted that the decomposition performed above allows a MIMO channel to be treated as a plurality of parallel single input single output SISO additive white Gaussian noise channels (AWGN), since only the diagonal values in the resulting triangular matrix are considered. Therefore any scalar codes which are appropriate for an AWGN channel may be selected for use or always used. In some cases, the codebooks which may be selected for use or always used are capacity achieving for a SISO AWGN channel whereas in other cases, the codebooks may not necessarily be capacity achieving. In some cases, the codebooks which may be selected for use or always used are of equal power, but in other cases this is not necessarily the case. In some cases, the number of codebooks may equal the number of submessages however in other cases, more or less codebooks may be used in other examples.

Once preparation method 500 has been completed or if preparation is currently not required (for instance because there has been no change in channel conditions or channel initialization and therefore the answer to stage 504 was no), transmission and reception of elements relating to the at least one message may take place. The elements may be transmitted or received for instance by antennas such as antennas 620.

The disclosure does not limit how transmission and reception takes place but for the sake of further illustration to the reader some transmission and reception examples will now be provided for various scenarios, with reference to FIGS. 7 to 21. In some of these example (or in other possible examples) the elements transmitted or received may include AWGN codes designed for SISO channels corresponding to the determined subrates, but in other examples this may not necessarily be the case.

In one example relating to FIGS. 7-10 is assumed that a transmitting node wishes to send elements relating to a common message (and possibly private message(s)) via two or three MIMO channels, for instance to two or three receiving nodes. Alternatively it is assumed that a transmitting node wishes to send elements relating to a message via an unknown channel out of two or three possible MIMO channels, for instance to a receiving node. Alternatively, it is assumed that a transmitting node wishes to send elements relating to a message via a MIMO channel with unknown noise, for instance to a receiving node.

FIG. 7 is a flowchart of an example of a transmission method 700 performed by a transmitting node, in accordance with the presently disclosed subject matter.

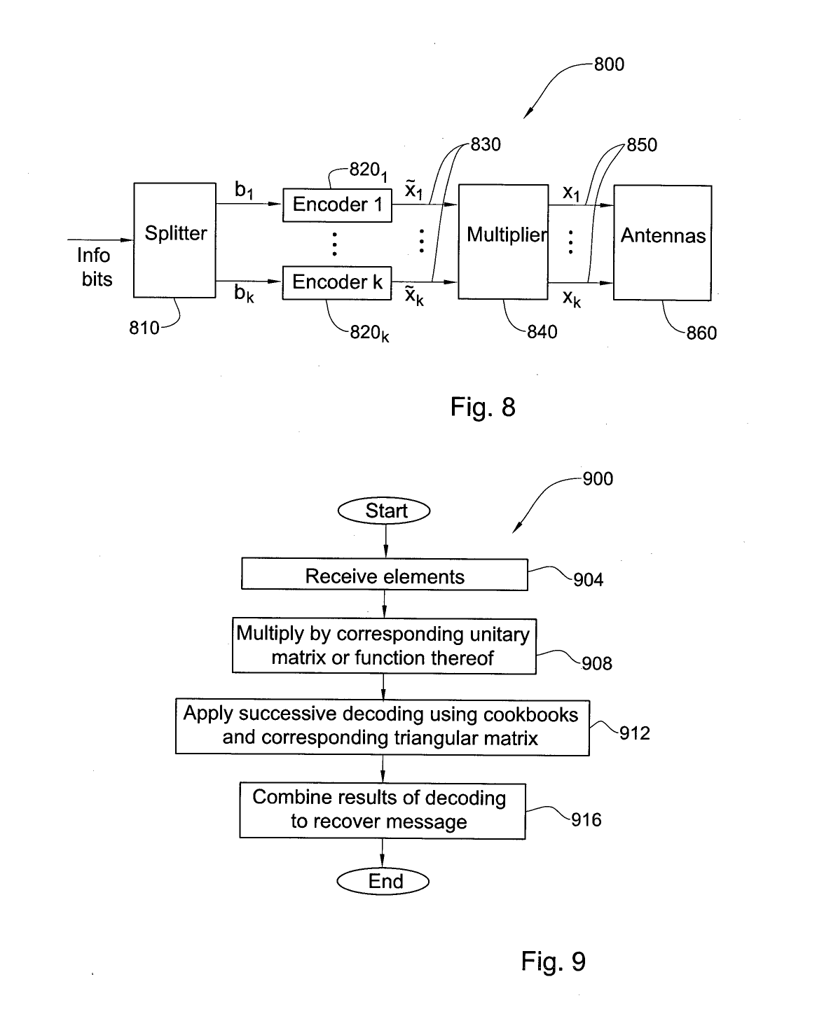

FIG. 8 is a block diagram of an example of a transmission system 800 at a transmitting node, in accordance with the presently disclosed subject matter. In the illustrated example, system 800 includes one or more splitter module(s) 810, one or more encoder module(s) 820, one or more multiplier module(s) 830 and/or one or more antennas module(s) 860.

In the illustrated example, in stage 704, transmission system 800, for instance splitter 810, splits the rate of the common message (and possibly private message(s)) into subrates (e.g. k subrates) corresponding to submessages (e.g. k submessages), in accordance with the rate determination in the last iteration of stage 516. For instance k may be the number of columns in the triangular matrix resulting from the decomposition.

In the illustrated example, in stage 708, transmission system 800, for instance encoder module 820 (including encoder 82₀₁ to 82₀ₖ) encodes the submessages.

For instance, k codebooks of equal power (or of non-equal power) may be used to encode the submessages. In another instance more or less codebooks may be used to encode the submessages. In some cases, the codebooks may include any codebooks which are appropriate for AWGN channels.

In some cases, the codebooks used are those determined in stage 518 or which are always used, and which correspond to the determined subrates.

Optionally preprocessing of the encoded submessages may be performed. Preprocessing may include for instance beamforming, minimum mean squared error etc.

In the illustrated example, in stage 712, transmission system 800 for instance multiplier 840, multiplies one of the resulting unitary matrices from stage 514, or a function thereof, by the encoded submessages in order to derive elements for transmission.

### Application 1: Common-Message Broadcast

In this application, a single node transmits a common message to several receiving nodes via (point to point) Gaussian MIMO channels. Each Gaussian MIMO channel may be given by

yᵢ=Hᵢx+nᵢ, i=1,2, . . . , N,

where x is the transmitted signal, subject to some power constraint.
The common-message capacity is the maximum achievable rate of a codebook that may be decoded with vanishing error probability by both users. It may be given by the compound-channel (worst-case) capacity expression:

C=max_{C}_{_{X}}min_{i=1,2, . . . ,N} log {det(I+HᵢC_{X}Hᵢ^{†})},

where the maximization is over all covariance matrices C_{X} subject to the power constraint. In Cₓ may be the optimal covariance matrix for C=max_{C}_{_{X}}min_{i=1,2, . . . ,N} log {det(I+HᵢC_{X}Hᵢ^{†})}, and therefore a function which yields

$$⌊ \begin{matrix}{H}_{i} \sqrt{{C}_{x}} \\ I\end{matrix} ⌋$$

may in some cases allow achievement of an optimal common message capacity. Proof that usage of this function may allow achievement of the optimal common message capacity is shown in the appendix. However, it is noted that in some cases, for instance where there is high SNR, optimality may sometimes be achieved without the usage of this function.

Additionally or alternatively, for instance, another possible function relating to augmented matrices concerns a common message sent to three receiving nodes. For the ease of explanation, it is assumed that the channel has the same number of receiving and transmitting antennas, i.e., the three channel matrices are square matrices. It is also assumed without loss of generality that the three channel matrices have the same determinant, namely,

detH₁=detH₂=detH₃.

Augmented channel matrices, denoted by [symbol] ₂, [symbol] ₂ and [symbol] ₃, may be developed which are block diagonal, where each block represent a channel matrix at a certain time instant. Namely,

$${ℋ}_{i} = ( \begin{matrix}{H}_{i} & 0 & … & 0 \\ 0 & {H}_{i} & … & 0 \\ ⋮ & ⋮ & ⋱ & ⋮ \\ 0 & 0 & … & {H}_{i}\end{matrix} ) .$$

For instance, refer to the decomposition described above for two channels and reproduced here

A₁=U₁D₁V^{†}

A₂=U₂D₂V^{†}

or to the decomposition described for three channels and reproduced here

[symbol]

₁^{†}A₁ [symbol] = [symbol] ₁

[symbol]

₂^{†}A₂ [symbol] = [symbol] ₂

[symbol]

₃^{†}A₃ [symbol] = [symbol] ₃,

For two channels, the unitary matrix V is common in both equations. For three channels, the Hermitian transpose of the unitary matrix [symbol] is common to the three equations. The unitary matrix V or a function thereof (for two channels) or the unitary matrix [symbol] or a function thereof (for three channels) is multiplied at the transmitting node since the transmitting node will be transmitting via both or all of the channels (or is unaware which of the possible channels, or under which possible noise conditions the node will be transmitting).

For example, assuming that \tilde{x} 830 represents the codeword vectors (e.g. with the first vector including the first entry of each encoded submessage, the second vector including the second entry of each encoded submessage, etc) then in a two channel example the transmission elements x 850 may be given by the equation

x=SV\tilde{x}

where V is the unitary matrix described above, and SV may be a function of the unitary matrix V. For instance the values of S may depend on the channel matrix or function thereof used in the decomposition. If the channel matrix was used in the decomposition then S may be the identity matrix or equivalently could be eliminated from the equation (meaning that V may be multiplied rather than a function of V). If a function of the channel matrix H was used in the decomposition, then SH may represent the function of the channel matrix that was decomposed in stage 514.

Continuing with the example of two receiving users, assume cases where the matrix decomposition was applied to

$$⌊ \begin{matrix}{H}_{i} \sqrt{{C}_{x}} \\ I\end{matrix} ⌋$$

and therefore let Fᵢ=Hᵢ\sqrt{Cₓ} for i=1,2. In these cases multiplier 840 may multiply the encoded submessages by V\sqrt{Cₓ} and therefore the transmission elements may be given by x=\sqrt{C_{X}}V\tilde{x}, where \sqrt{C_{X}} is a an example of the matrix S. Note that in other cases, the two channel decomposition may not have been applied to

$$⌊ \begin{matrix}{H}_{i} \sqrt{{C}_{x}} \\ I\end{matrix} ⌋$$

but to other matrices.

Similarly, for the case of more than three receiving users, the transmission elements x 850 may be given by the equation

x=S [symbol] \tilde{x}

It is noted that in the case of three channels the fact that U₁, U₂, U₃ and V are not square but rectangular may result in a small loss of rate, but this loss may become arbitrarily small if the number of time-slots if big enough.

In the illustrated example, in stage 716 transmission system 800 for instance antennas 860, transmit transmission elements x 850.

FIG. 9 is a flowchart of an example of a reception method 900 performed by a receiving node, in accordance with the presently disclosed subject matter.

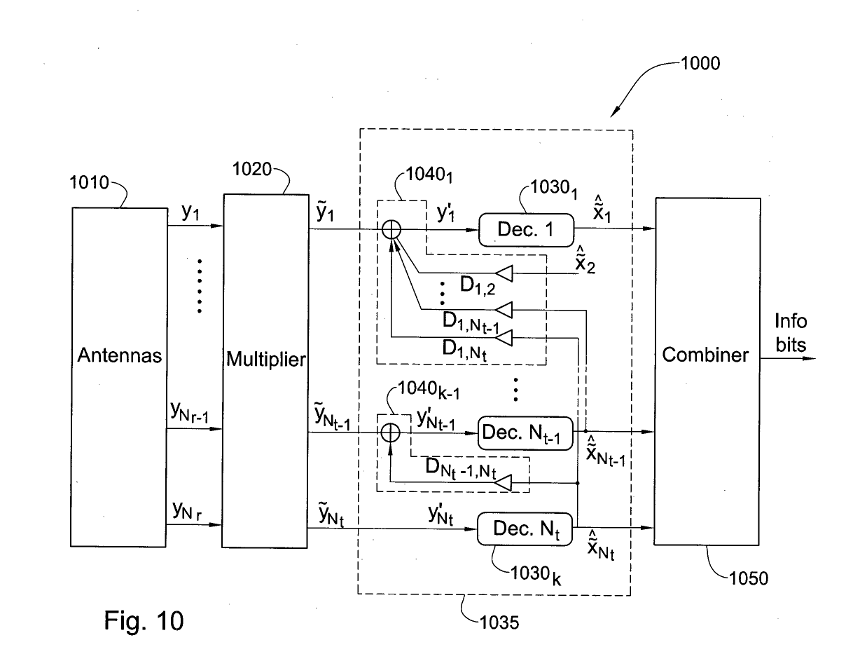

FIG. 10 is a block diagram of an example of a receiving system 1000 at a receiving node, in accordance with the presently disclosed subject matter. In the illustrated example, receiving system 1000 includes any of the following modules: one or more antennas module(s) 1010, one or more multiplier module(s) 1020, one or more decoder module(s) 1035, and/or one or more combiner module(s) 1040.

It may be assumed in some cases that a receiving node receives elements at least relating to a common message which were sent by a transmitting node via two or three MIMO channels, for instance to two or three receiving nodes. In these cases, each receiving node would have a receiving system 1000 and would perform method 900. Optionally, elements relating to private message(s) may also be received.

In the illustrated example, in stage 904, receiving system 1000 at a receiving node, for instance antennas 1010, receives via a MIMO channel elements, where the received element vector is denoted yᵢ with i referring to the receiving channel. Referring to equation 1A, the received element vector may be yᵢ=Hᵢx+nᵢ. For simplicity of description, noise is ignored from now in the remainder of the description of method 900. Recalling that the transmission elements x=SV\tilde{x} (for two channel scenario) or x=S [symbol] \tilde{x} for three channel scenario (see above stage 712), the received element vector can also be expressed as yᵢ=HᵢSV\tilde{x} (for two channel) or yᵢ=HᵢS [symbol] \tilde{x} (for three channel)

In the illustrated example, in stage 908, receiving system 1000, for instance multiplier 1020 multiplies the received elements by the corresponding unitary matrix from the decomposition of stage 514 or by a function thereof. For instance, the function may be the first k rows of the Hermitian transpose of the corresponding unitary matrix. The corresponding unitary matrix is the unitary matrix Uᵢ (for two channels) or [symbol] ᵢ (for three channels) from the decomposition representing the channel, via which the elements were received in stage 704. Assuming Ũᵢ includes the first k rows of the (corresponding) Uᵢ from the decomposition. Substituting for y, from above, the result of the multiplication may also be expressed as \tilde{y}ᵢ=Ũᵢ^{†}HᵢSV\tilde{x}

Replacing SHᵢ with the decomposition of aᵢUᵢDᵢV^{†} from stage 514, and cancelling Hermitian transposes the result of the multiplication may also be expressed as yᵢ=Dᵢ\tilde{x} where Dᵢ is the corresponding triangular matrix for the channel.

In the illustrated example, in stage 912 receiving system 1000, for instance successive decoder 1035 performs successive decoding (also known as successive interference cancellation SIC, minimum mean squared error estimation or VBlast) to recover the codeword vectors \tilde{x}. The terms successive decoding, successive interference cancellation, SIC, and variants thereof are used interchangeably herein.

For instance the system elements included in successive decoder 1035 may include k decoders 1030 which are operable to use k codebooks of equal power (or of non-equal power). In another instance more or less codebooks and/or decoders 1030 may be used for decoding. In some cases, the codebooks used are those determined in stage 518 or which are always used and which correspond to the determined subrates. In some cases, the codebooks may include any codebooks which are appropriate for AWGN channels.

Additionally or alternatively, for instance, the system elements included in successive decoder 1035 may include operators 1040 which are operable to perform subtraction of the results from multiplying earlier decoding results by values from the corresponding triangular matrix D. For instance, the successive decoding may be represented by the following equation

$${[ {y}_{i}^{′} ]}_{j} = {[ {\tilde{y}}_{i} ]}_{j} - {\sum }_{l = j + 1}^{{N}_{t}} {{[ {D}_{i} ]}_{j , l} [ {{x}^{\sim \hat{}}}_{i} ]}_{l} ,$$

where [ [symbol] ]ₗ is the decoded l-th codebook for channel i (or in other words the l-th decoded codeword vector).

For instance, one can define the signal-to-interference and noise ratio (SINR) for the decoding of the j-th codebook in decoder i in this process to be:

S_{i,j}=Var([\tilde{x}]ⱼ|\tilde{y}ᵢ,[\tilde{x}]ⱼ₊₁^{N}^{ₜ}).

Optimality of the successive decoding, assuming an example where the decomposition was performed on

$$⌊ \begin{matrix}{H}_{i} \sqrt{{C}_{x}} \\ I\end{matrix} ⌋$$

is shown in Theorem 2 of the appendix.

In the illustrated example, in stage 916 the receiving node, say combiner 1050 combines the results of the successive decoding to recover the message.

For instance, assuming the scenario where at least a common message is being communicated, the recovered message may include a common message and possibly also a private message. In another instance assuming the scenario where a message is being communicated via an unknown channel or via a channel with unknown noise, the recovered message may include that message.

In some examples, other postprocessing such as beamforming, etc may also take place during method 900.

### Application 2: Compound MIMO Channel

The methods and systems described above with reference to FIGS. 7-10 may be applicable in some examples to a compound MIMO channel, with the following changes. If elements relating to a message are to be transmitted via an unknown MIMO channel out of the two or three possible channels, for instance, then the transmission elements are transmitted via the channel which is unknown a-priori. Similarly, in this instance a receiving node receives elements relating to a message via one out of two or three possible MIMO channels, where the transmission channel was not known in advance by the transmitting node. In another instance, if elements relating to the message are to be transmitted via a MIMO channel with unknown noise, then the transmission elements are transmitted via that channel. Similarly, in this instance a receiving node receives elements relating to a message via a MIMO channel with actual noise conditions resembling one out of two or three possible conditions, where the actual noise conditions was not known in advance by the transmitting node.

### Application 3: Half-Duplex Rateless Relay

One possible function including augmented matrices (see description of stages 510-512 above) relates to the half-duplex relay scenario where a transmitting node sends elements relating a message to both a relay node and a receiving node, and the relay node transmits elements relating to the message to the receiving node, the elements passing via MIMO channels.

In this instance, the augmented channel matrix [symbol] ₁ may be a function of a channel between the transmitting node and relay node (H_{t, rel}), and augmented channel matrix. [symbol] ₂ may be a function of a channel between the transmitting node and the receiving node (H_{t, r}) and a channel between the relay node and the receiving node (H_{rel, r}). Note that since during the interval when both the transmitting node and relay node transmit to the receiving node, the relay has full knowledge of the message, the transmitting node and relay node may be considered as a single node that may coherently transmit over an effective multiple-access MIMO channel. Therefore, the augmented matrices in this scenario, [symbol] ₁ and [symbol] ₂, are given by

$${ℋ}_{1} = {ℋ}_{t , rel}$$

$${ℋ}_{2} = {ℋ}_{t , r} + {ℋ}_{rel , r} where$$

$${ℋ}_{t , rel} = [ \begin{matrix}{H}_{t ; rel} & 0 & … & 0 \\ 0 & 0 & … & 0 \\ ⋮ & ⋮ & ⋱ & ⋮ \\ 0 & 0 & … & 0\end{matrix} ] , \\ {ℋ}_{t , r} = [ \begin{matrix}{H}_{t ; r} & 0 & … & 0 \\ 0 & {H}_{t ; r} & … & 0 \\ ⋮ & ⋮ & ⋱ & ⋮ \\ 0 & 0 & … & {H}_{t ; r}\end{matrix} ] , \\ {ℋ}_{rel , r} = [ \begin{matrix}{H}_{rel ; r} & 0 & … & 0 \\ 0 & {H}_{rel ; r} & … & 0 \\ ⋮ & ⋮ & ⋱ & ⋮ \\ 0 & 0 & … & {H}_{rel ; r}\end{matrix} ] ;$$

where subscripts r, t and rel to indicate ‘receiver’, ‘transmitter’ and ‘relay’, respectively. Channel input dimensions are denoted by N and output dimensions by M. Channel matrices of dimensions M×N by Hare denoted with two subscripts, where the first subscript indicates the channel input (“originating node”), and the second indicates the channel output (“destination node”). Thus, the channel matrices H_{t,rel}, H_{t,r} and H_{rel,r} have dimensions Mᵣₑₗ×Nₜ, Mᵣ×Nₜ and Mᵣ×Nᵣₑₗ, respectively. [symbol] ₁ and [symbol] ₂ are the augmented channel matrices, of sizes mMᵣₑₗ×mNₜ and mMᵣ×mNₜ, respectively, where m equals the ratio between the total duration of the transmission and the duration when both the relay node and transmitting node are transmitting to the receiving node (as will be explained in more detail below). It is noted that the first Nᵣ⁽¹⁾ rows are sufficient for the matrix representation and the treatment discussed herein. Nevertheless, the all-zero rows are included to facilitate understanding.

Additionally or alternatively, in another instance, where it is assumed that one wants to take beamforming into account (e.g. S relates to beamforming matrice(s)), functions resulting from operations relating to beamforming and operations relating to half duplex relay augmented matrices may include the matrices [symbol] ₁, [symbol] ₂ where

[symbol]

₁= [symbol] _{t,rel} [symbol] ₜ

[symbol]

₂= [symbol] _{t,r} [symbol] ₜ+ [symbol] _{rel,r} [symbol] ᵣₑₗ,

where [symbol] _{t,rel} [symbol] _{t,r} [symbol] _{rel,r} are as above, and the beamforming matrices equal

$${ℬ}_{t} = [ \begin{matrix}{B}_{1} & 0 & … & 0 \\ 0 & {B}_{2} & … & 0 \\ ⋮ & ⋮ & ⋱ & ⋮ \\ 0 & 0 & … & {B}_{2}\end{matrix} ] , \\ {ℬ}_{rel} = [ \begin{matrix}0 & 0 & … & 0 \\ 0 & {B}_{rel} & … & 0 \\ ⋮ & ⋮ & ⋱ & ⋮ \\ 0 & 0 & … & {B}_{rel}\end{matrix} ] .$$

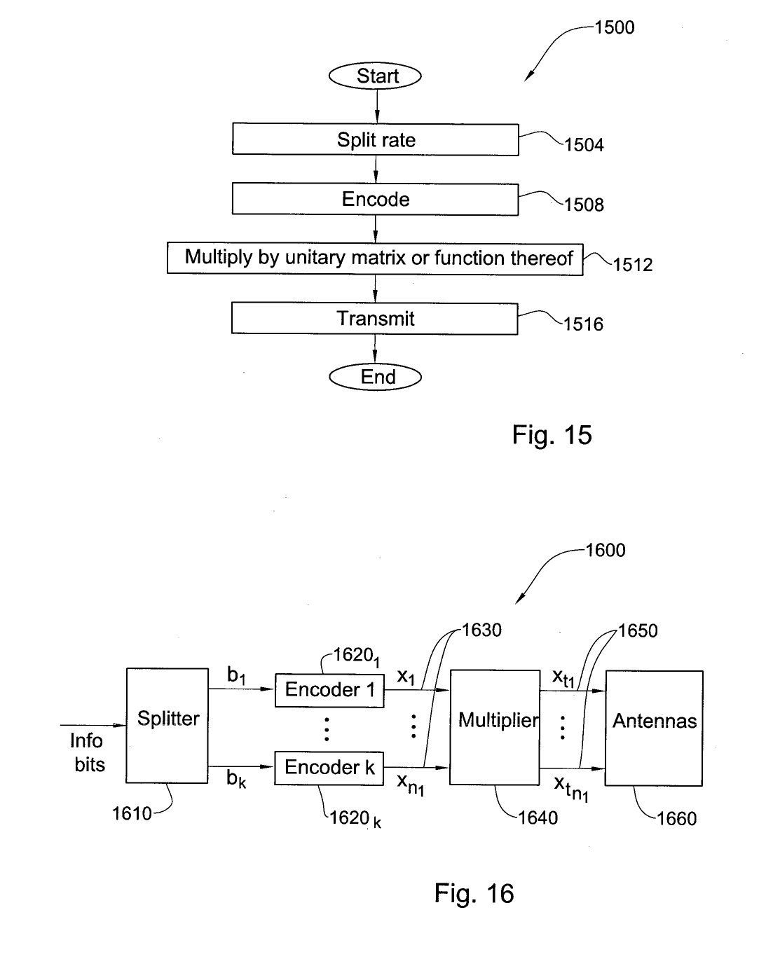

FIGS. 15-20 and FIGS. 21a and 21b relate to examples of a half duplex relay scenario. As discussed above, in a Gaussian MIMO relay channel, the transmitting node sends a signal to both the receiving node and the relay node, and the relay node transmits an additional signal to the receiving node. All signals pass through Gaussian MIMO channels:

yᵣₑₗ=H_{t,rel}xₜ+zᵣₑₗ,

yᵣ=H_{t,r}xₜ+H_{rel,r}xᵣₑₗ+zᵣ,

where x, y and z denote channel input, output and noise vectors, respectively, using subscripts r, t and rel to indicate ‘receiver’, ‘transmitter’ and ‘relay’, respectively. Channel input dimensions are denoted by N and output dimensions by M. We denote the channel matrices of dimensions M×N by H with two subscripts, where the first subscript indicates the channel input (“originating node”), and the second indicates the channel output (“destination node”). Thus, the channel matrices H_{t,rel}, H_{t,r}, and H_{rel,r} have dimensions Mᵣₑₗ×Nₜ, Mᵣ×Nₜ and Mᵣ×Nᵣₑₗ, respectively. In some cases, all channel inputs are subject to the same per symbol power constraint P.

In the “half-duplex” setting, at each time instant the relay may either receive or transmit, but not both simultaneously. In broadcast mode, the relay node and the receiving node receive information from the transmitting node for n₁ uses until the relay node is able to decode where

yᵣₑₗ=H_{t,rel}xₜ+zᵣₑₗ,

yᵣ=H_{t,r}xₜ+zᵣ,

If n₂ equals the total number of uses, then n₂−n₁ is the number of uses until the receiving node is able to decode the transmitted message as well. In multiple access (MAC) mode the transmitting node and relay node transmit coherently where

yᵣ=H_{t,r}xₜ+H_{rel,r}xᵣₑₗ+zᵣ.

For notational convenience, it is assumed that the relay node can receive and transmit at all times, but during the BC and MAC phases the relay node has zero transmit and receive gains, respectively. Moreover, since in the MAC stage, the relay node has full knowledge of the message, the transmitter node and the relay node can be considered as a single node that may coherently transmit over the effective multiple-input single-output channel. The half duplex scheme can therefore be represented in the following matrix form

φᵣₑₗ= [symbol] ₁χ+ζᵣₑₗ,

φᵣ= [symbol] ₂χ+ζᵣ,

where [symbol] ₁ and [symbol] ₂ are the augmented channel matrices, of sizes mMᵣₑₗ×mNₜ and mMᵣ×mNₜ, respectively. It is noted that the n₂ channel uses may be relates to the m channel inputs/outputs by interleaving, as will be described in more detail below. χ, φ and ζ the augmented input, output and noise vectors, respectively.

In this half duplex relay example, it is assumed that in method 500 the channel matrices H_{t, rel} H_{t,r} and H_{rel,r} are determined. Beamforming matrices may be selected in order to absorb the power constraints so that the input vector may have entries of unit power. Augmented matrices

[symbol]

₁= [symbol] _{t,rel} [symbol] ₜ

[symbol]

₂= [symbol] _{t,r} [symbol] ₜ+ [symbol] _{rel,r} [symbol] ᵣₑₗ,

are constructed. These augmented matrices are then decomposed as per equation 2 to obtain the matrices V, U₁ and U₂. Assuming m (=n₂/n₁) is integer, mNₜ rates are also determined as

$${R}_{j} = log \frac{{d}_{j}^{2}}{k}$$

where in this case the number of columns in [symbol] ₁ or [symbol] ₂ is mNₜ and therefore k=mNₜ. In some cases k (=mNₜ) codebooks, preferably optimal, are determined for scalar AWGN channels with these rates. The codes may be of length n₁. Alternatively, if the same codebooks are always used determination of codebooks during method 500 may be unnecessary, for instance because these always used codebooks may include sufficient rate options. Note that if m is a rational non-integer, rates and/or codebooks may be determined by taking an appropriate number k of non-zero entries on the diagonals of [symbol] ₁ and [symbol] ₂. In this case, since the rational numbers form a dense subset of the reals, any real ratio may be approached

FIG. 15 is a flowchart of an example of a transmission method 1500 performed by a transmitting node, in accordance with the presently disclosed subject matter.

FIG. 16 is a block diagram of an example of a transmission system 1600 at a transmitting node, in accordance with the presently disclosed subject matter. In the illustrated example, system 1600 includes one or more splitter module(s) 1610, one or more encoder module(s) 1620, one or more multiplier module(s) 1630 and/or one or more antennas module(s) 1660.

In the illustrated example, in stage 1504, transmission system 1600, for instance splitter 1610, splits the rate of the message into k subrates corresponding to k submessages.

In the illustrated example, in stage 1508 transmission system 1600, for instance encoder 1620 constructs n₁ vectors χ 1630 of length mNₜ using one sample from each codebook.

In the illustrated example, in stage 1512, transmission system 1600, for instance multiplier 1640 combine all the codewords by multiplying χ by a unitary matrix V or by a function of the unitary matrix V in order to receive χₜ 1650. For example the function may be a product of V and the beamforming matrix [symbol] ₜ where the beamforming matrix is an example of S discussed above. If m is integer then the dimensions of V and [symbol] ₜ would be mNₜ×mNₜ: For instance χₜ may be expressed as

χₜ= [symbol] ₜVχ.

It is assumed that the physical channel input xₜ is of dimensions Nₜ. Thus, to materialize a single input vector χₜ of length mNₜ, m physical channel inputs xₜ are needed

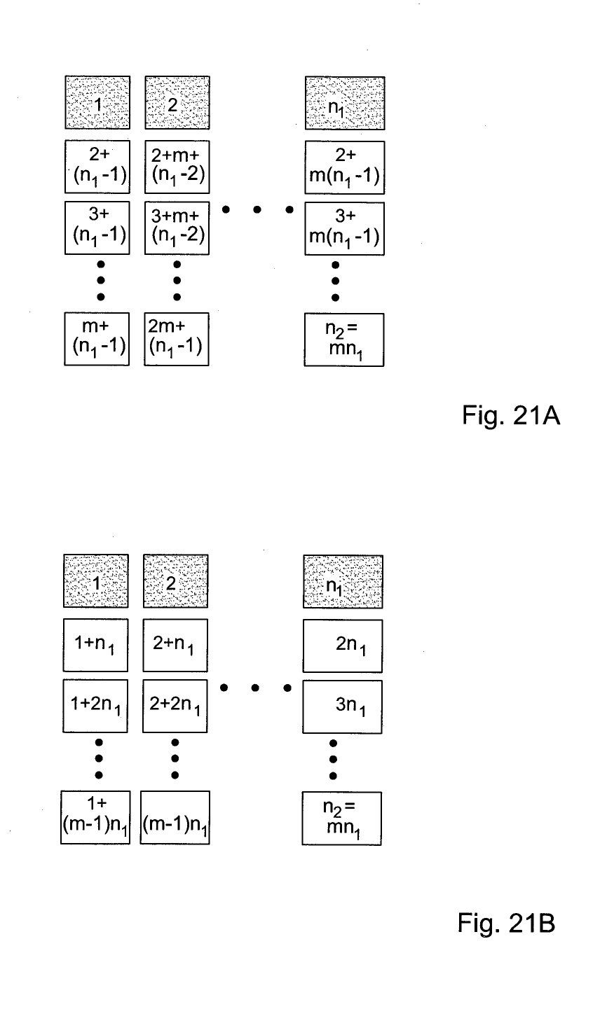

In the illustrated example in stage 1516 transmission system 1600, for instance antennas 1660 transmit. In the case where only the first Nₜ columns of [symbol] _{t,rel} are non-zero, sending χₜ or its first Nₜ entries followed by zeros, is equivalent. Thus, by transmitting, during each of the first n₁ (physical) channel uses, the first Nₜ entries of the appropriate augmented input χₜ, the whole χₜ vector can be transmitted over the channel [symbol] _{t,rel}. To accommodate for the second user (the columns of which are all non-zero, in t, rel general), the transmitting node then sends over the remaining (n₂−n₁) (physical) channel uses the remaining parts of the n₁ augmented vectors χₜ, in (any) systematic manner. Optionally, transmission system 1600, for instance an interleaving module, may perform interleaving. Further below the order of transmission will be discussed with reference to FIGS. 21a and 21b.

Optionally other pre-processing may be performed prior to transmitting stage 1516.

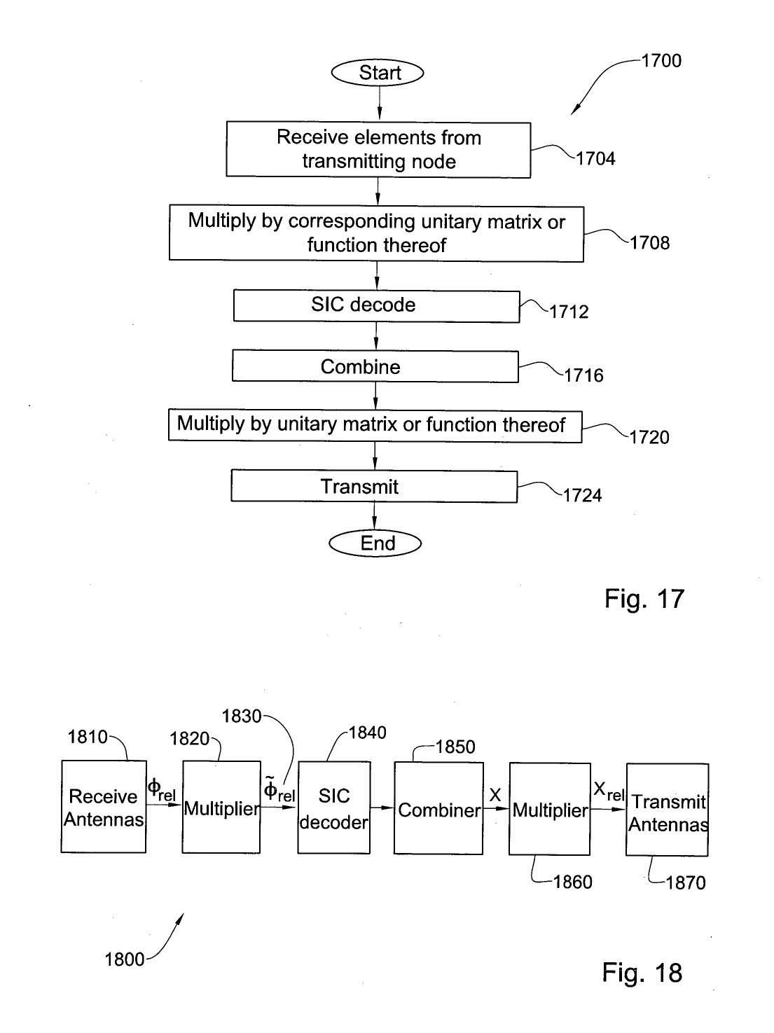

FIG. 17 is a flowchart of an example of a relay method 1700 performed by a relay node, in accordance with the presently disclosed subject matter.

FIG. 18 is a block diagram of an example of a relay system 1800 at a relay node, in accordance with the presently disclosed subject matter. In the illustrated example, relay system 1800 includes one or more receive antennas module(s) 1810, one or more multiplier module(s) 1820, one or more successive decoder module(s) 1840, one or more combiner module(s) 1850, one or more multiplier module(s) 1860 and/or one or more transmit antennas module(s) 1870.

In the illustrated example, in stage 1704, relay system 1800, for instance antennas 1810, receives the first n₁ output vectors.

φᵣₑₗ= [symbol] ₁χ+ζᵣₑₗ,

Recalling that χₜ= [symbol] ₜVχ. (see above stage 1512) and ignoring noise, the received element vector can also be expressed as φᵣₑₗ= [symbol] ₁ [symbol] ₜVχ

In the illustrated example, in stage 1708, relay system 1800, for instance multiplier 1820 multiplies the received vectors by the corresponding unitary matrix U₁ from the decomposition of stage 514 or by a function thereof. For instance, the function may be Ũ₁ of dimensions mNₜ×Nᵣ⁽¹⁾, which is equal to the first Nᵣ⁽¹⁾ columns of U₁. Note that the other columns of U₁ may be multiplied by zeros because of the zero columns in [symbol] ₁). Therefore \tilde{φ}rel=Ũ₁φᵣₑ

Substituting for φᵣₑ from above, the result of the multiplication can also be expressed as \tilde{φ}ᵣₑₗ=Ũ₁ [symbol] ₁ [symbol] ₜVχ Replacing [symbol] ₁ [symbol] ₜ with the decomposition of aᵢU₁D₁V^{†} from stage 514, and cancelling Hermitian transposes the result of the multiplication may also be expressed as \tilde{φ}ᵣₑₗ=aᵢD₁χ where D₁ is the corresponding triangular matrix for the channel.

In the illustrated example, in stage 1712 the relay system, for instance successive decoder 1840 performs successive decoding (also known as successive interference cancellation, minimum mean squared error estimation or VBlast) to recover the codeword vectors χ.

For instance the successive decoding may be represented by the following equation

$${[ {y}_{i}^{′} ]}_{j} = {[ {\tilde{y}}_{i} ]}_{j} - {\sum }_{l = j + 1}^{{N}_{t}} {{[ {D}_{i} ]}_{j , l} [ {{x}^{\sim \hat{}}}_{i} ]}_{l} ,$$

where [ [symbol] ]ₗ is the decoded l-th codebook for channel i (or in other words the l-th decoded codeword vector).

For instance, one can define the signal-to-interference and noise ratio (SINR) for the decoding of the j-th codebook in decoder i in this process to be:

S_{i,j}=Var([\tilde{x}]ⱼ|\tilde{y}ᵢ,[\tilde{x}]ⱼ₊₁^{N}^{ₜ}).

In the illustrated example, in stage 1716 relay system 1800, say combiner 1850 combines the results of the successive decoding to get χ.

In the illustrated example, in stage 1720, after decoding all the codewords constituting χ during the BC phase, relay system 1800 is able to join the transmitting node in transmission. Relay system 1800, for instance multiplier 1860 constructs a linear combination of the codewords χᵣₑₗ, i.e., χ multiplied by the unitary matrix V and by [symbol] ᵣₑₗ

χᵣₑₗ= [symbol] ᵣₑₗVχ.

Note that the left-most Nₜ zero columns in [symbol] ᵣₑₗ correspond to the BC phase (lasting n₁ channel uses), during which the relay only receives information.

In the illustrated example, in stage 1724, relay system 1800, for instance transmit antennas 1870, transmit χᵣₑₗ. Optionally, relay system 1800, for instance an interleaving module, may perform interleaving for instance using the same interleaving as being used at the transmitter. Interleaving will be discussed further below with reference to FIGS. 21a and 21b

In some cases other preprocessing and/or post processing may be performed during method 1700.

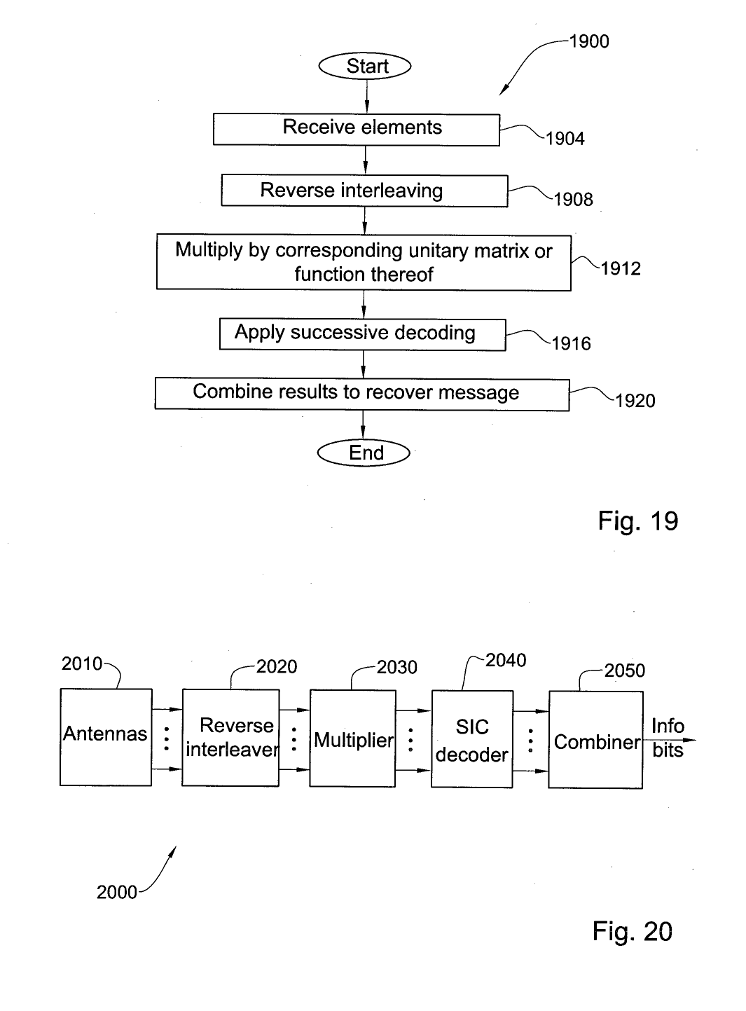

FIG. 19 is a flowchart of an example of a receiving method 1900 performed by a receiving node, in accordance with the presently disclosed subject matter.

FIG. 20 is a block diagram of an example of receiving system 2000 at a receiving node, in accordance with the presently disclosed subject matter. In the illustrated example, receiving system 2000 includes one or more antennas module(s) 2010, one or more reverse interleaver module(s) 2020, one or more multiplier module(s) 2030, one or more SIC decoder module(s) 2040, and/or one or more combiner module(s) 2050.

In the illustrated example, in stage 1904, receiving system 2000, for instance antennas 2010 receive the first n₁ vectors sent only by the transmitting node, and then the remaining (n₂−n₁) vectors transmitted by both the transmitting node and the relay node.

In the illustrated example, in stage 1908 after receiving all the vectors, receiving system 2000, for instance reverse interleaver 2020 reverses the interleaving used at the transmitting node and/or the relay node, if any. Thus, receiving system 200 effectively observes n₁ received vectors χ passing through a MIMO AWGN noise channel described by [symbol] ₂.

φᵣ= [symbol] ₂χ+ζᵣ,

In other examples, where interleaving was not performed at the transmitting node and/or the relay node, stage 1908 may be omitted from method 1900 and reverse interleaver 2020 may be omitted from receiving system 2000.

In the illustrated example, in stage 1912, receiving system 2000 for instance multiplier 2030 multiplies each such equivalent vector by U₂ of dimensions mNₜ×mNᵣ⁽²⁾,

In the illustrated example, in stage 1916, receiving system 2000 for instance decoder 2040 decodes the codebooks using SIC.

For instance the successive decoding may be represented by the following equation

$${[ {y}_{i}^{′} ]}_{j} = {[ {\tilde{y}}_{i} ]}_{j} - {\sum }_{l = j + 1}^{{N}_{t}} {{[ {D}_{i} ]}_{j , l} [ {\tilde{x}}_{i}^{\hat{}} ]}_{l} ,$$

where [ [symbol] ]ₗ is the decoded l-th codebook for channel i (or in other words the l-th decoded codeword vector), and D is the corresponding triangular matrix for the “effective” channel resulting from the decomposition of the corresponding augmented matrix.

For instance, one can define the signal-to-interference and noise ratio (SINR) for the decoding of the j-th codebook in decoder i in this process to be:

$${S}_{i , j} = \frac{{( {[ {D}_{i} ]}_{j , j} )}^{2}}{{[ {C}_{\tilde{z}} ]}_{j , j} + {\sum }_{l = 1}^{j - 1} {( {[ {D}_{i} ]}_{j , l} )}^{2}}$$

In the illustrated example, in stage 1920 relay system 2000, say combiner 2050 combines the results of the successive decoding to recover the message.

In some cases, other post processing may be performed during method 1900.

For the methods and systems discussed above with reference to the half duplex scenario, in cases where interleaving is performed, different orderings (“interleaving”) of the sub-vectors χₜ (and χᵣₑₗ) are possible. In some of these cases, any ordering/interleaving of the sub-vectors xₜ, whose first n₁ elements are the sub-vectors composed of the first Nₜ entries of each of the vectors χₜ, followed by any ordering of the rest, may be valid. Two examples of such orderings will now be discussed with reference to FIG. 21a and FIG. 21b.

FIGS. 21a and 21b illustrate examples of interleaving/ordering of transmitted vectors, in accordance with the presently disclosed subject matter. In these figures each rectangle represents a physical input vector xₜ of length Nₜ; each column represents an augmented input vector χₜ of length mNₜ; the indices inside the rectangle represent the transmission ordering; rectangles with fill are received by both the relay node and the receiving node, whereas rectangles with no fill are designated for the receiving node only.

The ordering illustrated in FIG. 21a may allow construction of the vectors φᵣ in the fastest manner possible; this, in turn, may expedite the processing of these vectors, viz., applying the unitary transformation U₂. The second ordering of interest, depicted in FIG. 21b, is the systematic ordering according to which first the first Nₜ entries (“first layer”) of each of the vectors χₜ are sent, followed by the next Nₜ entries (“second layer”) of each of the vectors χₜ, etc.; this ordering may possibly be implemented more easily, may be “more systematic”, and may be suitable for cases of more relays, where each relay, starts to transmit after a different number of channel uses, in which case the first “layer” is the least common multiple (LCM) of {nᵢ}, the number of uses needed by each of the relays and the final receiver, to recover reliably the transmitted codewords.

It is noted that the scheme described with reference to FIGS. 15 to 21a and 21b may in some cases also be applicable to the SISO (“scalar”) special case.

### Application 4: Incremental Redundancy Codes

Assume now a scenario with incremental redundancy (IR) (or “rateless”) over a broadcast channel. Changing the notation on equation 1A for ease of understanding, the broadcast channel may be given by

yᵢ=Hᵢxₜ+zᵢ,

where yᵢ is an Nᵣ⁽ⁱ⁾×1 vector, x denotes the Nₜ×1 complex-valued input vector limited to an average power P per symbol, Hᵢ the Nᵣ⁽ⁱ⁾×Nₜ complex channel matrix to receiving node i, and zᵢ is assumed to be a circularly-symmetric Gaussian vector of zero mean and identity covariance matrix.

It is noted that incremental redundancy coding plays an important role in many communication problems as a means to efficiently cope with channel uncertainty. The design of IR coding schemes recently has received strong interest in the coding community, motivated by a number of emerging applications in Gaussian network, e.g. as a means of facilitating multicasting and/or relaying. In classic multicasting, one wishes to optimize the input probability distribution such that the minimal mutual information, corresponding to the worst channel with respect to this input, is maximized. In this way, one guarantees the same transmission rate to all the users, whereas users which have higher mutual information do not exploit their excess rates, and wait until the end of the transmission block before recovering the message. In some scenarios, however, this excess mutual information can be utilized to shorten the transmission period required by the stronger users to recover reliably the message, by designing an appropriate rateless scheme. An interesting special case of the aforementioned problem is that of a single user transmitting over a known channel but unknown signal-to-noise ratio (SNR), both remaining constant (“slow fading”) throughout the whole transmission.

In a two-user rateless setting, the transmitting node needs to send the same k bits to both receiving nodes. Each receiving node “listens” to the transmission from time instance 1 until the receiving node is able to reliably decode all bits, and then the receiving node may tune out. The online time of receiving node i, nᵢ, is the number of channel uses which the receiving node requires in order to reliably decode, and the resulting effective rates are given by

$${R}_{i} = ⌊ \frac{k}{{n}_{i}} ⌋ , \qquad i = 1 , 2 ,$$

where └•┘ denotes the “floor” operation.

Assuming an effective rates pairs (R₁,R₂)m under power constraint P is achievable if and only if there exists a covariance matrix K with trace[K]≦P such that

$$\frac{R ( {H}_{i} , K )}{{R}_{i}} + {{C}_{i} [ \frac{1}{{R}_{i}} - \frac{1}{{R}_{\overline{1}}} ]}^{+} \geq 1 , \qquad i = 1 , 2 ,$$

where [a]⁺=max {a,0} and

$$\overline{1} = \{ \begin{matrix}2 & i = 1 \\ 1 & i = 2.\end{matrix}$$

Note that in some examples, the two user rateless scenario may be regarded as special case of the (half-duplex) “rateless relay” problem, where the relay node tunes in until it is able to decode, but does not transmit any signal. In effect, relay system 1800 and relay method 1700 may be adapted into a system and a method for a receiving node respectively. In one example, to adapt to the two user rateless scenario, modules 1860, 1870 may be omitted from relay system 1800, stages 1720 to 1724 may be omitted from method 1700, and method 1900 and system 2000 may relating to receipt only from the transmitting node. Additionally or alternatively, in another example the half duplex relay scenario may be transformed into a two user rateless scenario by assigning B₂=0 in

$${ℬ}_{t} = [ \begin{matrix}{B}_{1} & 0 & … & 0 \\ 0 & {B}_{2} & … & 0 \\ ⋮ & ⋮ & ⋱ & ⋮ \\ 0 & 0 & … & {B}_{2}\end{matrix} ] , \\ {ℬ}_{rel} = [ \begin{matrix}0 & 0 & … & 0 \\ 0 & {B}_{rel} & … & 0 \\ ⋮ & ⋮ & ⋱ & ⋮ \\ 0 & 0 & … & {B}_{rel}\end{matrix} ] .$$

Similarly, the half duplex scenario may be adapted into a two user rateless scenario using additional or alternative techniques in other examples.

In some examples, augmenting matrices may allow the design of an incremental redundancy scheme, without necessarily adapting the half duplex relay scheme. For instance, in one example where for simplicity of description it is assumed that there are two users, the number of uses of the worse channel may be augmented sufficiently, with the augmented matrix denoted, say, as [symbol] ₂. The number of uses for the better channel may be augmented so that the accumulated quality (e.g. capacity) is the same as [symbol] ₂. These will be less uses than those of [symbol] ₂ so blocks of zero may be added until there are the same number of uses. The augmented matrix for the better channel may be denoted, say, as [symbol] ₁. Incremental redundancy or Hybrid-ARQ type II codes may allow earlier decoding of elements received via the channel with better channel quality, compared to a naïve scheme where elements received via the better channel and elements via the worse channel are decoded at the same time.

### Application 5: Two Way Relay

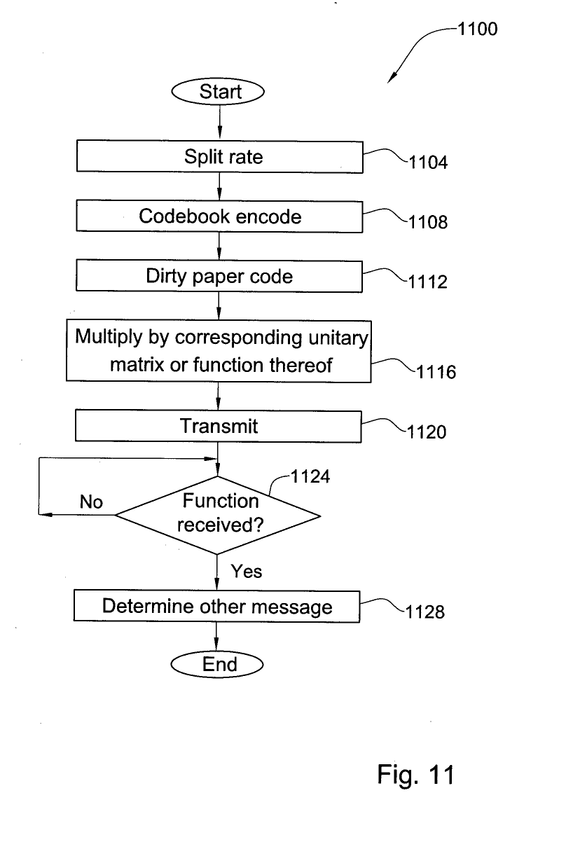

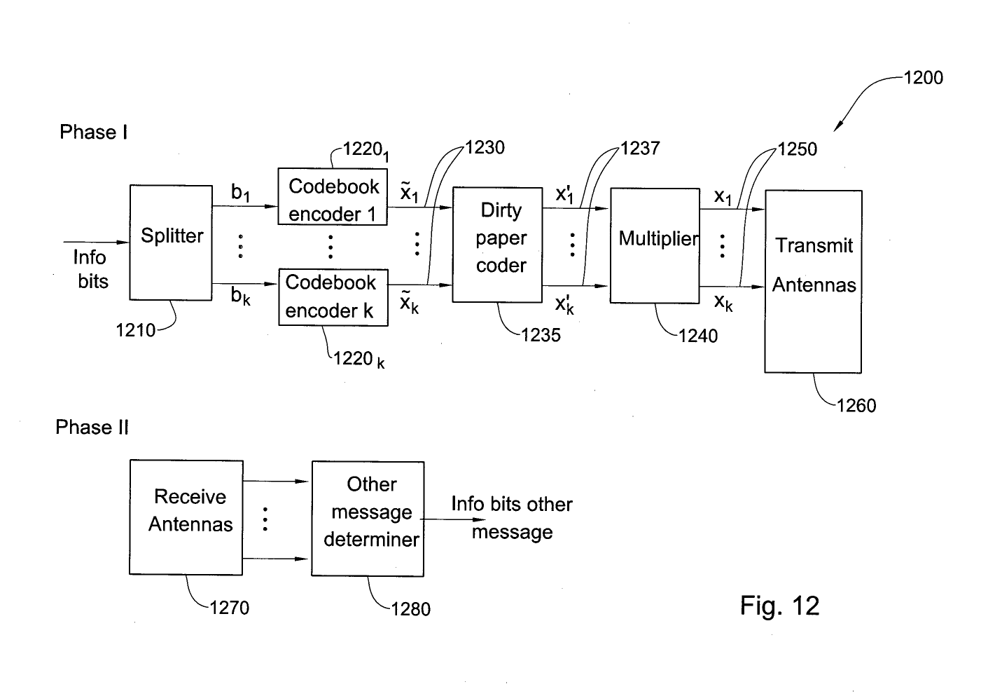

In one example relating to FIG. 11 and FIG. 12 is assumed that two terminating nodes wish to communicate private messages with one another via a relay node. Each terminating node may perform exchange method 1100 and include exchange system 1200.

FIG. 11 is a flowchart of an example of a private message exchange method 1100 performed by a terminating node, in accordance with the presently disclosed subject matter.

FIG. 12 is a block diagram of an example of a private message exchange system 1200 at a terminating node, in accordance with the presently disclosed subject matter. In the illustrated example, system 1200 includes one or more splitter module(s) 1210, one or more codebook encoder module(s) 1220, one or more dirty paper coding module(s) 1235, one or more multiplier module(s) 1240, one or more message determiner module(s) 1280, one or more module(s) of transmit antennas 1260, and/or one or more module(s) of receive antennas 1270.

In the illustrated example, in stage 1104, exchange system 1200, for instance splitter 1210, splits the rate of the common message into subrates (e.g. k subrates) corresponding to submessages (e.g. k submessages), in accordance with the decision in the last iteration of stage 516. For instance k may be the number of columns in the triangular matrix resulting from the decomposition.

In the illustrated example, in stage 1108, exchange system 1200, for instance encoders 1220 (including encoder 1220₁ to 1220ₖ) encode the submessages, where the encoded submessages are shown as \tilde{x}.

For instance, k codebooks of equal power (or of non-equal power) may be used to encode the submessages. In another instance more or less codebooks may be used to encode the submessages. In some cases, the codebooks may include any codebooks which are appropriate for AWGN channels.

In some cases, the codebooks used are those determined in stage 518 or which are always used and which correspond to the determined subrates.

Optionally preprocessing of the encoded submessages may be performed. Preprocessing may include for instance beamforming, minimum mean squared error etc.

In the illustrated example, in stage 1112, exchange system 1200, for instance dirty paper coder 1235, further encodes the submessages, obtaining x′. Examples of dirty paper coding are known in the art and include Costa precoding, Tomlinson-Harashima precoding and/or the vector perturbation technique of Hochwald et al.

In the illustrated example, in stage 1116 exchange system 1200, for instance multiplier 840, multiplies encoded submessages x′ by the corresponding unitary matrix Uᵢ (which corresponds to the channel between this terminating node and the relay) from the decomposition of stage 514, or by a function thereof in order to derive elements for transmission. For instance, a possible function may be the first k rows of the Hermitian transpose of the corresponding unitary matrix multiplied by S.

For example, assume that x′ 1237 represents the codeword vectors after dirty paper coding (e.g. with the first vector including the first entry of each encoded submessage, the second vector including the second entry of each encoded submessage, etc) then the transmission elements x 850 may be given by the equation x=SŨᵢ^{†}x′ where Ũᵢ consists of the first k rows of the (corresponding) Uᵢ from the decomposition, and the values of S depend on the channel matrix or function thereof used in the decomposition. If the channel matrix was used in the decomposition then S may be the identity matrix or equivalently could be eliminated from the equation. If a function of the channel matrix H was used in the decomposition, then SH may represent the function of the channel matrix that was decomposed in stage 514.

Continuing with this example, assume cases where the decomposition was applied to

$$⌊ \begin{matrix}{H}_{i} \sqrt{{C}_{x}} \\ I\end{matrix} ⌋$$

and therefore let FᵢHᵢ\sqrt{Cₓ} for channel i corresponding to this terminating node. In these cases multiplier 840 may multiply the encoded submessages by Ũᵢ^{†}\sqrt{Cₓ} and therefore the transmission elements x 1250 may be given by x=Ũᵢ^{†}\sqrt{Cₓ} x′, where \sqrt{C_{X}} is a an example of the matrix S.

In the illustrated example, in stage 1120 exchange system 1200, for instance transmit antennas 1260, transmit transmission elements x 1250 to the relay node.

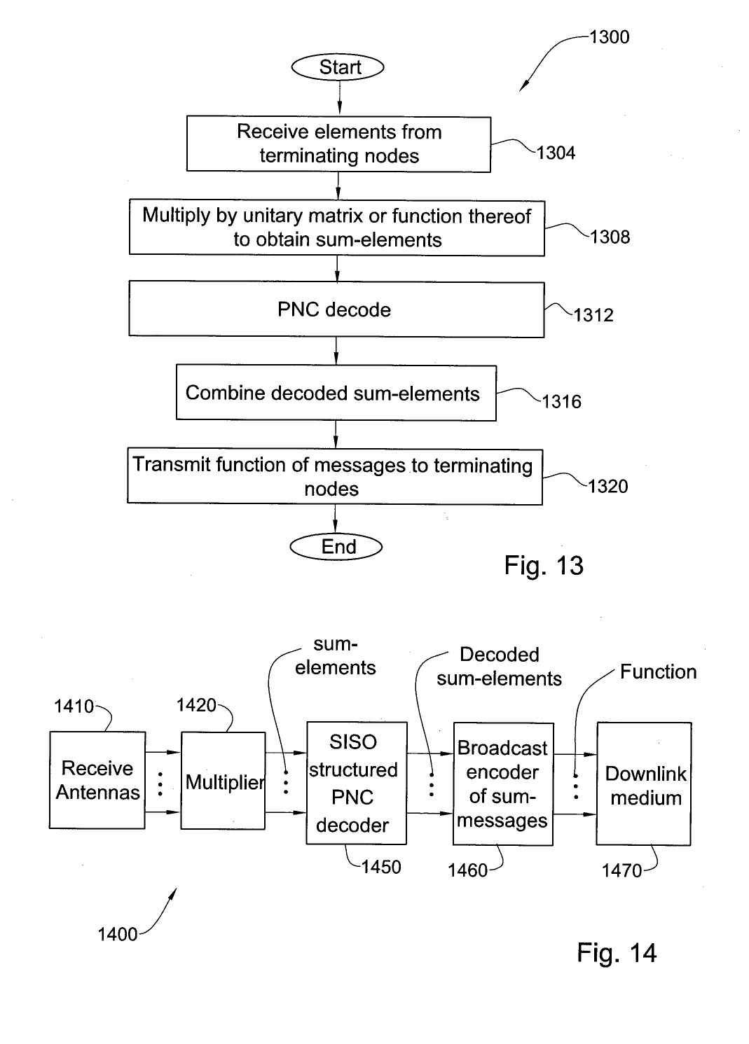

In the illustrated example, method 1100 waits in stage 1124 to continue the method until a function of the private messages being exchanged is received from the relay node (as will be explained in more detail below with reference to FIGS. 13 and 14).

In the illustrated example once exchange system 1200, for instance receive antennas 1270 receives a function of the private messages from the relay node (yes to stage 1124) exchange system 1200, for instance determiner 1280 determines from the received function the message from the other terminating node in stage 1128.

The disclosure does not limit the way in which the function of the private messages is transmitted and received, nor how the message from the other terminating node is determined from the function. However for the sake of further illustration to the reader, some possibilities will now be presented.

For instance, determiner 1280 may be operable to extract the private message originating at its own terminating node from the received function of the private messages and thereby be left with the message from the other terminating node. In some cases of this instance, the extraction may include a subtraction modulo a lattice of the message originating from its own terminating node.

In some cases, the relay node may have sent the function of the private messages as a common message via two MIMO channels to the two terminating nodes, where the MIMO channels may or may not be the same as the channels used by the relay node to receive the messages from the terminating nodes. In some of these cases, method 500 may have been performed by the relay node and terminating nodes prior to the transmission of the common message (which in these cases is the function of the private messages). In these cases the relay node may have performed method 700 prior to sending the common message, and the terminating node may perform method 900 after receiving the common message. However in these cases before or after performing stage 916, the message of the terminating node may be extracted from the results of the decoding of the common message (for instance by subtracting modulo a lattice) in order to remain with the message from the other terminating node.

FIG. 13 is a flowchart of an example of a relay method 1300 performed by a relay node, in accordance with the presently disclosed subject matter.

FIG. 14 is a block diagram of an example of a relay system 1400 at a relay node, in accordance with the presently disclosed subject matter. In the illustrated example, relay system 1400 includes one or more antennas module(s) 1410, one or more multiplier module(s) 1420, a one or more structured PNC decoder module(s) 1450, one or more broadcast encoder module(s) of sum-messages 1460 and/or one or more downlink medium module(s) 1470.

In one example relating to FIG. 13 and FIG. 14 is assumed that the relay node has received private messages from two terminating nodes which are to be exchanged.

In the illustrated example, in stage 1304, relay system 1400, for instance antennas 1410, receives elements relating to two private messages via two MIMO channels from two terminating nodes, where the received element vector is denoted y Referring to equation 1B, the received element vector may be expressed as y=H₁x₁+H₂x₂+noise For simplicity of description, the noise is ignored in the rest of the description of method 1300. Recalling that for each channel the transmission elements were x=BŨᵢ^{†}x′ (see above stage 116), the received element vector may also be expressed as y=+H₁SŨ₁^{†}x′+H₂SŨ₂^{†}x₂′ (For simplicity's sake it is assumed that S is the same for both channels)

For instance if S=\sqrt{C_{X}}, then y=H₁\sqrt{C_{X}}Ũ₁^{†}x₁′+H₂\sqrt{C_{X}}Ũ₂^{†}x₂′

As the received element vector is composed of elements received via either of two MIMO channels therefore referring again to the decomposition described above and reproduced here

A₁=U₁D₁V^{†}

A₂=U₂D₂V^{†}

the Hermitian transpose of the unitary matrix V is common in both equations and therefore the unitary matrix V, or a function thereof, is multiplied by relay system 1400, for instance by multiplier 1420 in stage 1308. The multiplication yields sum-elements \tilde{y}. Assuming V was multiplied the sum elements may be expressed as

y=H₁VSŨ₁^{†}x₁′+H₂VSŨ₂^{†}x₂′

After replacing SH; with the decomposition of aᵢUᵢDᵢV^{†} from stage 1116, and cancelling Hermitian transposes, the result of the multiplication may also be expressed as y=D₁x₁′+D₂x₂′

where Dᵢ is the corresponding triangular matrix for the channel corresponding to xᵢ.

In some cases, the sum-elements correspond to a sum modulo a lattice of encoded submessages x.

In some cases, modulo a lattice relates to the dirty paper coding performed at the terminating nodes (see stage 1112), such as Tomlinson-Harashima or other coding.

It is known that a relay node may be able to decode a combination codeword even it cannot decode the individual codewords. This premise was first presented in M. P. Wilson, K. Narayanan, H. Pfister, and A. Sprintson for the simple two-way relay channel in the work “Joint physical layer coding and network coding for bi-directional relaying”, which is hereby incorporated by reference herein. Structured physical layer network coding “PNC” uses structured/linear codes, building on the property that an integer linear combination of codewords is a codeword as well. A relay node may be able to decode the combination codeword, even if it cannot decode the individual messages. This approach may in some cases solve both bottleneck and noise accumulation effects at the same time.

In the illustrated example, in stage 1312 relay system 1400 for instance, structured PNC decoder (1450) decodes the sum-messages (combination of codewords), thereby resulting in decoded sum-elements.

Depending on the instance of PNC decoding, the PNC decoding may or may not include codebooks corresponding to certain subrates based on the decomposition.

In the illustrated example, in stage 1316 relay system 1400, say encoder 1460 encodes the decoded sum-elements, thereby resulting in a function of the private messages being exchanged.

In some examples, other postprocessing such as beamforming, etc may also take place during method 1300.

In the illustrated example, in stage 1320 relay system 1400, for instance downlink medium 1470 transmit the function of the private messages to the terminating nodes.

The disclosure does not limit the way in which the function is transmitted. However for the sake of further illustration to the reader, some possibilities will now be presented.

For instance, in some cases, the relay node may send the function of the private messages as a common message via two MIMO channels to the two terminating nodes, where the MIMO channels may or may not be the same as the channels used by the relay node to receive the messages from the terminating nodes. In some of these cases, method 500 may have been performed by the relay node and terminating nodes prior to the transmission of the common message (which in these cases is the function of the private messages). In these cases the relay node may perform method 700 prior to sending the common message.

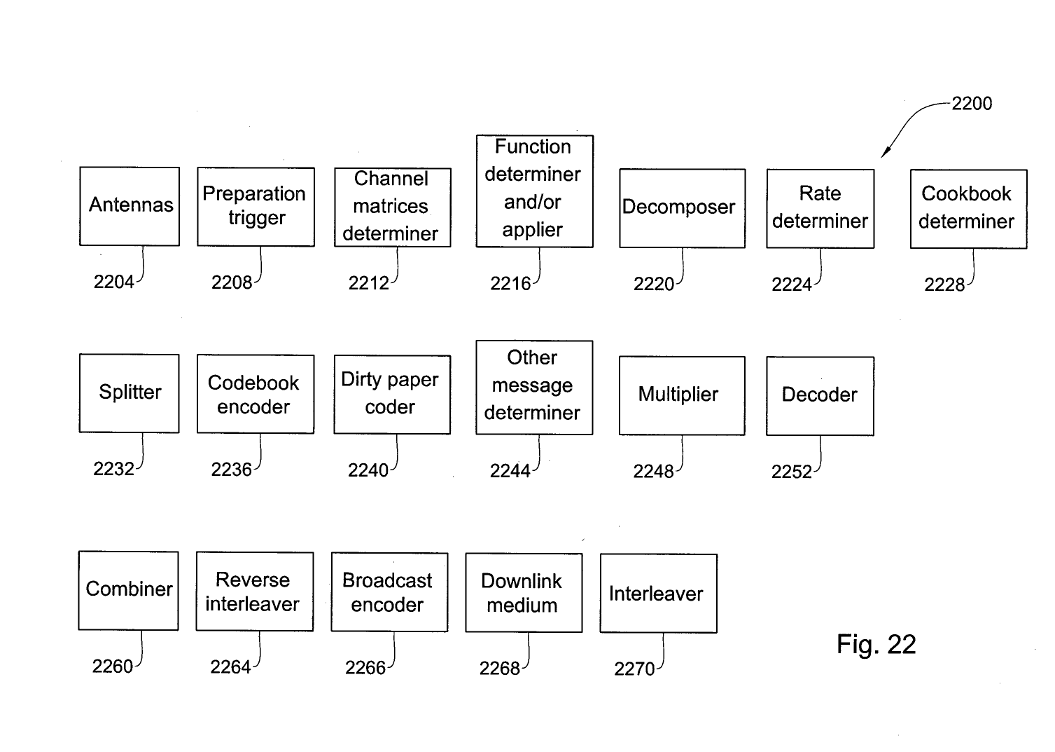

FIG. 22 illustrated a system 2200 at a node operable to transmit, exchange, relay and/or receive, in accordance with the presently disclosed subject matter.

In the illustrated example, system 2200 may include any of the following: one or more antennas module(s) 2204 (e.g. antennas 620, 860, 1010, 1260,1270, 1410, 1660, 1810, 1870, 2010), one or more preparation triggerer module(s) 2208 (e.g. 610), one or more channel matrices determiner module(s) 2212 (e.g. 630), one or more function determiner and applier module(s) 2216 (e.g. 640), one or more decomposer module(s) 2220 (e.g. 650) one or more rate determiner module(s) 2224 (e.g. 660), one or more codebook determiner module(s) 2228 (e.g. 670), one or more splitter module(s) 2232 (e.g. 810, 1210, 1610) one or more codebook encoder module(s) 2236 (e.g. 820, 1220, 1620), one or more dirty paper coder module(s) 2240 (e.g. 1235), one or more other message determiner module(s) 2244 (e.g. 1280), one or more multiplier module(s) 2248 (e.g. 840, 1020, 1240, 1420, 1640, 1820, 1860, 2030), one or more decoder module(s) 2252 (e.g. successive decoder module(s) 2252 1035, 1840, 2040 and/or e.g. structured PNC decoder module(s) 1450), one or more combiner module(s) 2260 (e.g. 1050, 1850, 2050), one or more broadcast encoder module(s) 2266 (e.g. 1460), one or more downlink medium module(s) 2268 (e.g. 1470) and/or one or more interleaver module(s) 2270 (e.g. at a transmitting node, at a relay node), and/or one or more reverse interleaver module(s) 2264 (e.g. 2020).

It is noted that in some cases the successive decoding described in the examples above, does not necessarily require equal rates per codebook, and therefore does not necessarily inflict an unbounded rate penalty. Not requiring equal rates may in some of these cases be advantageous compared to applying a QR decomposition when successively decoding. In various cases of the examples described above, the gain and/or total capacity corresponding to each triangular matrix may or may not be equal.

Depending on the example, the various modules of any system described herein may be located at the same location, or may be located at different locations. Depending on the example, any of the modules described herein may be operable to perform any of the functions attributed to that module or to a different module. Regardless of whether a particular module is referred to in the single or plural form herein, in various examples one or more of the module may be present. Depending on the example, any of the modules described herein may be made up of any combination of software, hardware and/or firmware operable to perform the functions described and explained herein. In some cases, one or more of the systems described herein or any part(s) thereof may comprise a machine specially constructed for the desired purposes, and/or may comprise a programmable machine selectively activated or reconfigured by specially constructed program code. In some cases, one or more of the systems described herein may include at least some hardware.

Alternatively to the examples shown in the figures, any system may in some examples include fewer, more and/or different modules than shown in the corresponding figure. Alternatively to the examples shown in the figures, a different number of a particular module may be included in a system than shown in the corresponding figure. Alternatively to the examples described herein, functionality of any system may in some examples be divided differently, for instance among modules illustrated in the corresponding figure and/or in other figure(s). Alternatively to the examples described herein, any system may in some examples include additional, less, and/or different functionality than described with reference to that system. Alternatively to the examples described herein, modules described as separate may in some examples be combined, and/or any one module may in some examples be separated into a plurality of modules.

Alternatively to the examples shown in the figures, stages which are shown as being executed sequentially may in some examples be executed in parallel and/or stages shown as being executed in parallel may in some examples be executed sequentially. Alternatively to the examples shown in the figures, any method may in some examples include more, less and/or different stages than illustrated in the corresponding figure. Alternatively to the examples shown in the figures, stages may in some examples be executed in a different order than illustrated.

It will also be understood that the subject matter contemplates that a system or part of a system disclosed herein may be for example a suitably programmed machine. Likewise, the subject matter contemplates, for example, a computer program being readable by a machine for executing a method or part of a method disclosed herein. Further contemplated by the subject matter, for example, is a machine-readable memory tangibly embodying program code readable by the machine for executing a method or part of a method disclosed herein.

While examples of the subject matter have been shown and described, the subject matter is not thus limited. Numerous modifications, changes and improvements within the scope of the subject matter will now occur to the reader.

### APPENDIX

This appendix presents some theorems on which some of the presently disclosed subject matter is based, and formally proves the theorems.

To construct a joint equi-diagonal triangularization (JET) use the geometric mean decomposition (GMD), according to which any matrix A of dimensions m×n and rank k may be decomposed as

A=U₁DU₂^{†}, (4)

where U₁ and U₂ are m×k and n×k (respectively) matrices with orthonormal columns and D is a k×k upper-triangular matrix with a constant diagonal equal to the geometric mean of the non-zero singular values of A. Also use the QR and RQ decompositions according to which A can be factorized as

A=QR, (5)

or alternately as

A=\tilde{R}V^{T}, (6)

where Q and V are m×m and n×n unitary matrices, respectively, and R and \tilde{R} are m×n “generalized upper triangular” matrices (matrices with zero entries beneath the main ° diagonal, i.e., [Rᵢⱼ]=0 for i>j) with non-negative diagonals.

These decompositions allow the proof of the following theorem.

Theorem 1 Let A₁ and A₂ be complex-valued matrices, of dimensions m₁×n and m₂×n, respectively. Assume that m₁,m₂≧n and that the matrices have full rank (rank n). Then A₁ and A₂ may be jointly decomposed as

$${A}_{1} = {a}_{1} {U}_{1} {D}_{1} {V}^{†} \\ {A}_{2} = {a}_{2} {U}_{2} {D}_{2} {V}^{†} , \\ and \\ {a}_{i} \sqrt[n]{{\prod }_{j = 1}^{n} {σ}_{i , j}} , \qquad ( 7 )$$

where U₁, U₂ and V are unitary of dimensions m₁×m₁, m₂×m₂ and n×n, respectively; D₁ and D₂ are generalized upper-triangular matrices with non-negative equal diagonal elements, and where

$${\{ {σ}_{i , j} \}}_{j = 1}^{n}$$

are the singular values of Aᵢ.
Proof: Before considering the general case, the theorem for the case when the matrices are square will be proven.
Square Case (m₁=m₂=n):

In this case A₁ and A₂ are invertible. Denote

$${a}_{i} = \sqrt[n]{\vert det ( {A}_{i} ) \vert} .$$

Thus, one may apply the GMD to the matrix B, defined below:

$$B = \frac{{A}_{1}}{{a}_{1}} {( \frac{{A}_{2}}{{a}_{2}} )}^{- 1} = {U}_{1} R {U}_{2}^{†} , \qquad ( 8 )$$

where the matrices U₁, U₂, R are as in (4).

Now, apply RQ decompositions to Uᵢ^{†}Aᵢ/aᵢ (i=1,2) to achieve

$${U}_{i}^{†} \frac{{A}_{i}}{{a}_{i}} = {D}_{i} {V}_{i}^{†} , \qquad ( 9 )$$

where Dᵢ and Vᵢ are as in (6). By substituting (9) into (8), one obtains

U₁D₁V₁^{†}V₂D₂⁻¹U₂^{†}=U₂RU₂^{†},

which is equivalent to

V₁^{†}V₂=D₁⁻¹RD₂. (10)

The l.h.s. of (1) is unitary, whereas its r.h.s. is an upper-triangular matrix with a non-negative diagonal. An equality between such matrices can hold only if both matrices are equal to the identity matrix of the appropriate dimensions (n×n). Thus, one obtains

V=V₁=V₂.

[D₁]ᵢᵢ=[R]ᵢᵢ[D₂]ᵢᵢ, i=1, . . . , n,

where [X]ᵢⱼ denotes the (i,j) entry of the matrix X.

Since the diagonal of R is constant and is equal to the geometric mean of the singular values of B, which, in turn, is equal to [R]ᵢᵢ=1 (for all i), we have

[D₁]ᵢᵢ=[D₂]ᵢᵢ,

Thus, we established the desired decomposition (7)
Larger Row Dimension Case (m₁, m₂≧n):

Start by decomposing Aᵢ using QR decompositions:

AᵢQᵢRᵢ, i=1,2,

where Qᵢ and Rᵢ are as in (5). Since Aᵢ is full-rank and mᵢ≧n, the diagonal elements of Rᵢ are all (strictly) positive and the entries on its lower (mᵢ−n) rows are all zeros. Denote the n×n upper sub-matrices of Rᵢ by \tilde{R}ᵢ. Since \tilde{R}ᵢ are non-singular square matrices, invoking the proof for the square case (above), one may decompose them as

\tilde{R}₁=a₁Ũ₁\tilde{D}₁V^{†}

\tilde{R}₂=a₂Ũ₂\tilde{D}₂V^{†}

Now, construct the augmented unitary matrices W:

$${W}_{i} = ( \begin{matrix}{\tilde{U}}_{i} & 0 \\ 0 & {I}_{{m}_{i} - n}\end{matrix} ) ,$$

and the generalized triangular matrices Dᵢ of dimensions mᵢ×n:

$${D}_{i} = ( \begin{matrix}{\tilde{D}}_{i} \\ 0\end{matrix} ) .$$

Thus, one arrives at the desired decomposition of A₁ and A₂ (equation 7), with Uᵢ=QᵢWᵢ.
Theorem 2 Let V, U₁ and U₂ be given by

$$⌊ \begin{matrix}{H}_{i} \sqrt{{C}_{x}} \\ I\end{matrix} ⌋$$

Let d be the diagonal of the corresponding D₁ or D₂, and let \tilde{Y}ᵢ be the first Nₜ rows of Uᵢ. The rates

$${R}_{j} = log \frac{{d}_{j}^{2}}{k}$$

### and SINRs

$${S}_{i , j} = \frac{{( {[ {D}_{i} ]}_{j , j} )}^{2}}{{[ {C}_{\tilde{z}} ]}_{j , j} + {\sum }_{l = 1}^{j - 1} {( {[ {D}_{i} ]}_{j , l} )}^{2}} )$$

are related by

Rⱼ=log(1+S_{1,j})=log(1+S_{2,j}), j=1, . . . , Nₜ (11)

and furthermore

$${\sum }_{j = 1}^{{N}_{t}} {R}_{j} = logdet ( I + {H}_{i} {C}_{X} {H}_{i}^{†} ) . \qquad ( 12 )$$

Proof: The received signal is

yᵢFᵢV\tilde{x}+z=\tilde{F}ᵢ+z.

### Recalling

$$⌊ \begin{matrix}{H}_{i} \sqrt{{C}_{x}} \\ I\end{matrix} ⌋$$

one can define an augmented matrix for the \tilde{F}ᵢ channels:

$$\begin{matrix}{\tilde{G}}_{i} = [ \begin{matrix}{\tilde{F}}_{i} \\ I\end{matrix} ] = [ \begin{matrix}I 0 \\ 0 {V}^{†}\end{matrix} ] {G}_{i} V = [ \begin{matrix}I 0 \\ 0 {V}^{†}\end{matrix} ] {U}_{i} {D}_{i} \\ = {W}_{i} {D}_{i} .\end{matrix}$$

Now it is noted that Wᵢ is unitary, thus one has arrived at a OR decomposition of \tilde{G}ᵢ. Also note that the first Nₜ rows of Wᵢ equal Ũᵢ. Therefore each of the decoders is exactly an MMSE-VBLAST decoder for \tilde{F}ᵢ. Now (11) follows (for each decoder) by Lemma III.3 in the paper “Uniform channel decomposition for MIMO communications” by Y. Jiang, W. Hager, and J. Li, which is hereby incorporated by reference herein. Furthermore,

$${\sum }_{j = 1}^{{N}_{t}} {R}_{j} = log det ( I + {\tilde{F}}_{i} {\tilde{F}}_{i}^{†} ) = log det ( I + {F}_{i} {F}_{i}^{†} ) , \qquad ( 13 )$$

where the first equality follows by Corollary III.4 of the same paper by Jiang et al., and the second holds since V is unitary. Since this is equivalent to (12), the proof is completed.

By (11), the successive decoding procedure will succeed with arbitrarily low probability of error for rates approaching R. By (12), the sum of the codebook rates equals the mutual information over the channels. Taking C_{X} be the covariance matrix maximizing C=max_{C}_{_{X}}min_{i=1,2, . . . ,N} log {det(I+HᵢC_{X}Hᵢ^{†})}, capacity is achieved.

Theorem 3 is now introduced which will be used in order to prove the joint equi-diagonal decomposition of three matrices
Theorem 3 Let A₁ and A₂ be the two n×n complex valued matrices, with determinants equal to 1. Define the Nn=Nn augmented matries,

$${𝒜}_{i} = ( \begin{matrix}{A}_{i} & 0 & … & 0 \\ 0 & {A}_{i} & … & 0 \\ ⋮ & ⋮ & ⋱ & ⋮ \\ 0 & 0 & … & {A}_{i}\end{matrix} ) .$$

Then there exist three nN×n(N−n+1) matrices [symbol] ₁, [symbol] ₂, [symbol] with orthonormal columns, such that

[symbol]

ᵢ^{†} [symbol] ᵢ

[symbol]

are upper-triangular, with only 1s on the diagonal.
Proof: One can accomplish the decomposition using three steps:

### Joint Triangularization

Start by jointly triangularizing the matrices A₁ and A₂ using the joint equi-triangularization decomposition (JET) discussed above with reference to theorem 1:

$${( {U}_{i}^{JET} )}^{†} {A}_{i} {V}^{JET} = ( \begin{matrix}{r}_{1} & * & … & * \\ 0 & {r}_{2} & … & * \\ ⋮ & ⋮ & ⋱ & ⋮ \\ 0 & 0 & … & {r}_{n}\end{matrix} ) .$$

Now apply this transformation to each block separately:

$${𝒜}_{i}^{JET} = {( {𝒰}_{i}^{JET} )}^{†} {𝒜}_{i} {𝒱}^{JET} , \\ where \\ {𝒰}_{i}^{JET} = ( \begin{matrix}{U}_{i}^{JET} & 0 & … & 0 \\ 0 & {U}_{i}^{JET} & … & 0 \\ ⋮ & ⋮ & ⋱ & ⋮ \\ 0 & 0 & … & {U}_{i}^{JET}\end{matrix} ) \\ {𝒱}^{JET} = ( \begin{matrix}{V}^{JET} & 0 & … & 0 \\ 0 & {V}^{JET} & … & 0 \\ ⋮ & ⋮ & ⋱ & ⋮ \\ 0 & 0 & … & {V}^{JET}\end{matrix} ) . \qquad ( 14 )$$

### Reordering

It will now be convenient to re-order the columns of [symbol] ᵢ^{JET} such that columns kn,kn+(n−1),kn+2(n−1), . . . , kn+(n−1)² will become “grouped together” for every k, noting that this set includes exactly one symbol for each of n consecutive channel uses Formally, one does so by introducing the following nN×n(N−n+1) re-ordering matrix O:

$${O}_{ij} = \{ \begin{matrix}1 & i = {π}_{j} \\ 0 & Otherwise ;\end{matrix} \qquad ( 15 )$$

where the function π is defined as follows:

$$For 1 \leq j \leq n ( N - n + 1 ) , {π}_{j} = ( n - 1 ) \cdot [ ( j - 1 ) \% n ] + n \cdot ⌊ \frac{j - 1}{n} ⌋ + n .$$

As a result of this re-ordering, one obtains an upper-triangular (N−n+1)n×(N−n+1)n matrix, which has a block-triangular structure:

$${O}^{T} {𝒜}_{i}^{JET} O = ( \begin{matrix}Λ & * & … & * & * \\ 0 & Λ & … & * & * \\ ⋮ & ⋮ & ⋮ & ⋱ & ⋮ \\ 0 & 0 & … & Λ & * \\ 0 & 0 & … & 0 & Λ\end{matrix} ) , \\ where$$

$$Λ = ( \begin{matrix}{r}_{n} & 0 & … & 0 \\ 0 & {r}_{n - 1} & … & 0 \\ ⋮ & ⋮ & ⋱ & ⋮ \\ 0 & 0 & … & {r}_{1}\end{matrix} ) .$$

### GMD

Since the matrix Λ does not depend on i, one can decompose it using GMD:

Λ=U^{GMD}T(V^{GMD})^{†},

where T is upper-triangular with only 1s on its diagonal.

Now apply the GMD to all the blocks of O^{T} [symbol] ᵢ^{JET}O:

$${𝒰}^{GMD} = ( \begin{matrix}{U}^{GMD} & 0 & … & 0 \\ 0 & {U}^{GMD} & … & 0 \\ ⋮ & ⋮ & ⋱ & ⋮ \\ 0 & 0 & … & {U}^{GMD}\end{matrix} )$$

$${𝒱}^{GMD} = ( \begin{matrix}{V}^{GMD} & 0 & … & 0 \\ 0 & {V}^{GMD} & … & 0 \\ ⋮ & ⋮ & ⋱ & ⋮ \\ 0 & 0 & … & {V}^{GMD}\end{matrix} ) ,$$

to obtain:

$${( {𝒰}_{i}^{GMD} )}^{†} {O}^{T} {𝒜}_{i}^{JET} O {𝒱}^{GMD} = ( \begin{matrix}{T}_{i} & * & … & * & * \\ 0 & {T}_{i} & … & * & * \\ ⋮ & ⋮ & ⋮ & ⋱ & ⋮ \\ 0 & 0 & … & {T}_{i} & * \\ 0 & 0 & … & 0 & {T}_{i}\end{matrix} ) , \qquad ( 16 )$$

where Tᵢ are upper-triangular with only 1s on the diagonal.

We now combine (16) with (14) to obtain:

$${𝒰}_{i}^{†} {𝒜}_{i} 𝒱 = ( \begin{matrix}{T}_{i} & * & … & * & * \\ 0 & {T}_{i} & … & * & * \\ ⋮ & ⋮ & ⋮ & ⋱ & ⋮ \\ 0 & 0 & … & {T}_{i} & * \\ 0 & 0 & … & 0 & {T}_{i}\end{matrix} ) , \\ where \\ {𝒰}_{i} = {𝒰}_{i}^{JET} O {𝒰}^{GMD} \\ 𝒱 = {𝒱}^{JET} O {𝒱}^{GMD} , \qquad ( 17 )$$

Using Theorem 3 one can now prove the following theorem, which allows the joint equi-diagonal decomposition of 3 channel matrices.
Theorem 4 Let H₁, H₂, and H₃ be complex-valued matrices, of dimensions n×n, such that

detH₁=detH₂=detH₃.

Define three Nn×Nn augmented channel matrices:

$${ℋ}_{i} = ( \begin{matrix}{H}_{i} & 0 & … & 0 \\ 0 & {H}_{i} & … & 0 \\ ⋮ & ⋮ & ⋱ & ⋮ \\ 0 & 0 & … & {H}_{i}\end{matrix} ) , i = 1 , 2 , 3.$$

Then [symbol] ₁, [symbol] ₂, [symbol] ₃ can be jointly decomposed as

[symbol]

₁^{†} [symbol] ₁ [symbol] = [symbol] ₁

[symbol]

₂^{†} [symbol] ₂ [symbol] = [symbol] ₂

[symbol]

₃^{†} [symbol] ₃ [symbol] = [symbol] ₃,

where [symbol] ₁, [symbol] ₂, [symbol] ₃, [symbol] are nN×n(N−(n−1)) matrices with orthonormal columns, and [symbol] ₁, [symbol] ₂, [symbol] ₃ are square upper-triangular matrices with equal diagonals.
Proof: Start by defining the following two nN×nN matrices:

[symbol]

₁= [symbol] ₁ [symbol] ₃⁻¹

[symbol]

₁= [symbol] ₁ [symbol] ₃⁻¹. (18)

Following Theorem 3, there exist three nN×n(N−n+1) matrices [symbol] ₁, [symbol] ₂, [symbol] ₃ with orthonormal columns, such that

[symbol]

ᵢ^{†} [symbol] ᵢ [symbol] (19)

are upper-triangular, with only 1s on the diagonal.

Now perform the following QR decompositions:

[symbol]

₃⁻¹ [symbol] ₃= [symbol] S,

where V is of dimensions nN×n(N−n+1) with orthonormal columns, and S is an n(N−n+1)×n(N−n+1) upper-triangular matrix. Thus, using (18) and (19), one obtains the following equalities:

[symbol]

₁^{†} [symbol] ₁ [symbol] S= [symbol] ₁

[symbol]

₂^{†} [symbol] ₂ [symbol] S= [symbol] ₂

[symbol]

₃^{†} [symbol] ₃ [symbol] S=I.

Multiplying by S⁻¹ on the right yields:

[symbol]

₁^{†} [symbol] ₁ [symbol] = [symbol] ₁S⁻¹

[symbol]

₂^{†} [symbol] ₃ [symbol] = [symbol] ₂S⁻¹

[symbol]

₃^{†} [symbol] ₃ [symbol] =S⁻¹.

Since [symbol] ₁ and [symbol] ₂ are upper-triangular with only 1s on the diagonal, the following three matrices

[symbol]

₁= [symbol] ₁S⁻¹

[symbol]

₂= [symbol] ₂S⁻¹

[symbol]

₃=S⁻¹

have equal diagonals, which completes the proof.

1. A method of communicating at least one message, comprising:
jointly decomposing at least two MIMO channel matrices or functions thereof, wherein a result of said decomposing includes triangular matrices and unitary matrices;
determining how to split a rate of said at least one message into subrates corresponding to submessages of said at least one message based on diagonal values in said resulting triangular matrices; and
transmitting or receiving elements relating to said at least one message.

2. The method of claim 1, further comprising:
determining codebooks corresponding to said determined subrates.

3. The method of claim 1, further comprising:
determining a function of a channel matrix, wherein said function of said channel matrix is decomposed rather than said channel matrix.

4. The method of claim 3, wherein said function includes an augmented matrix.

5. The method of claim 3, wherein said function takes into account at least one selected from a group comprising: a covariance matrix and a beamforming matrix.

6. (canceled)

7. The method of claim 1, wherein two channel matrices or functions thereof are jointly decomposed.

8. The method of claim 1, wherein three channel matrices or functions thereof are jointly decomposed

9. The method of claim 1, wherein said resulting triangular matrices have equal diagonals.

10. The method of claim 1, wherein said elements may include codes designed for single input single output SISO additive white Gaussian noise AWGN channels corresponding to said determined subrates.

11. The method of claim 1, further comprising:
splitting a rate of said at least one message into said determined subrates corresponding to submessages;
using codebooks to encode said submessages, wherein said codebooks correspond to said determined subrates; and
multiplying a resulting unitary matrix or a function thereof by said encoded submessages to derive said elements for transmission.

12. The method of claim 11, wherein said function of said unitary matrix is at least one selected from a group comprising:
a product of said resulting unitary matrix and a factor which was multiplied by a channel matrix in order to derive a function of said channel matrix,
and
a product of a submatrix of a Hermitian transpose of said resulting unitary matrix and a factor which was multiplied by a channel matrix in order to derive a function of said channel matrix

13. (canceled)

14. The method of claim 11, wherein said at least one message includes a common message, wherein elements relating to said common message are transmitted via at least two MIMO channels whose channel matrices or functions thereof were jointly decomposed, and wherein said resulting unitary matrix which is multiplied or whose function is multiplied is common to a decomposition of each said channel matrix or function thereof.

15. (canceled)

16. The method of claim 11, wherein said at least one message includes a private message, and wherein said elements are to be transmitted to a relay node, said method further comprising:
applying dirty paper coding;
wherein said resulting unitary matrix or said function thereof is multiplied by said submessages which had been encoded using said codebooks and said dirty paper coding, and wherein said resulting unitary matrix which is multiplied or whose function is multiplied corresponds to a MIMO channel via which said elements are to be transmitted to said relay node.

17. The method of claim 16, further comprising receiving a function of said private message and of at least one other private message originating from at least one other node; and
determining said at least one other private message.

18. The method of claim 11, wherein said elements are transmitted via a channel out of a plurality of possible channels which is not known beforehand or via a known channel with unknown noise.

19. The method of claim 11, wherein some of said elements are transmitted to one node and others of said elements are transmitted to a plurality of nodes.

20. The method of claim 1, further comprising:
multiplying elements which were received, by a unitary matrix resulting from said decomposing or by a function thereof; and
decoding.

21. The method of claim 20, wherein said function of said unitary matrix is a submatrix of a Hermitian transpose of said unitary matrix.

22. The method of claim 20, wherein said at least one message includes a common message, wherein elements relating to said common message had been transmitted via at least two MIMO channels, wherein said unitary matrix is a unitary matrix corresponding to one of said channels via which said elements were received, and wherein said decoding includes applying successive decoding based on a corresponding resulting triangular matrix and codebooks corresponding to said determined subrates, said method further comprising: combining results of said successive decoding to recover at least said common message.

23. The method of claim 20, wherein said at least one message includes at least two private messages and said related elements were received from at least two nodes, wherein said unitary matrix is a common unitary matrix resulting from a decomposition of each channel matrix or function thereof, and wherein said decoding includes structured physical layer network coding PNC decoding, said method further comprising: encoding results of said structured PNC decoding to obtain a function of said private messages; and
transmitting said function of said private messages to said at least two nodes.

24. The method of claim 20, wherein said received elements include elements sent by a transmitting node and elements sent by a relay node, wherein said unitary matrix resulted from a decomposition of an augmented matrix; and wherein said decoding includes successive decoding based on a corresponding resulting triangular matrix and codebooks corresponding to said determined subrates, said method further comprising:
combining results of said decoding to recover said at least one message

25. (canceled)

26. The method of claim 20, wherein said received elements include elements sent by a transmitting node to a relay node, wherein said unitary matrix resulted from a decomposition of an augmented matrix, and wherein said decoding includes applying successive decoding based on a corresponding resulting triangular matrix and codebooks corresponding to said determined subrates; said method further comprising:
combining results of said decoding;
multiplying results of said combining by a common unitary matrix resulting from said decomposing or by a function thereof to derive elements for transmitting to at least one other node; and
transmitting said derived elements to said at least one other node.

27. The method of claim 20, wherein said unitary matrix resulted from a decomposition of an augmented matrix which was formed in a block diagonal manner from channel matrices in a plurality of instances, and wherein said decoding includes successive decoding based on a corresponding resulting triangular matrix and codebooks corresponding to said determined subrates, said method further comprising: combining results of said decoding to recover said at least one message.

28. A system for communicating at least one message, comprising:
a decomposer operable to jointly decompose at least two MIMO channel matrices or functions thereof, wherein a result of said decomposing includes triangular matrices and unitary matrices;
a rate determiner operable to determine how to split a rate of said at least one message into subrates corresponding to submessages of said at least one message based on diagonal values in said resulting triangular matrices; and
antennas operable to transmit or receiving elements relating to said at least one message.

29. The system of claim 28, further comprising: a codebook determiner operable to determine codebooks corresponding to said determined subrates.

30. The system of claim 28, further comprising: a function determiner operable to determine a function of a channel matrix, wherein said function of said channel matrix is decomposed rather than said channel matrix.

31. The system of claim 28, further comprising:
a splitter operable to split a rate of said at least one message into said determined subrates corresponding to submessages;
an encoder operable to encode said submessages, wherein said codebooks correspond to said determined subrates; and
a multiplier operable to multiply a resulting unitary matrix or a function thereof by said encoded submessages to derive said elements for transmission.

32. The system of claim 31, further comprising:
a dirty paper coder operable to apply dirty paper coding;
wherein said multiplier is operable to multiply said resulting unitary matrix or said function thereof by said submessages which had been encoded using said codebooks and said dirty paper coding, and wherein said resulting unitary matrix which is multiplied or whose function is multiplied corresponds to a MIMO channel via which said elements are to be transmitted to said relay node.

33. The system of claim 28, further comprising:
a multiplier operable to multiply elements which were received, by a unitary matrix resulting from said decomposition or by a function thereof; and
a decoder operable to decode.

34. The system of claim 33, wherein said decoder includes at least one selected from a group comprising:
a successive decoder operable to apply successive decoding based on at least one resulting triangular matrix and codebooks corresponding to said determined subrates,
and
a structured physical layer coding PNC decoder operable to perform structured PNC decoding.

35-36. (canceled)

37. The system of claim 33, further comprising: a combiner operable to combine results of said decoding.
